(19) United States
(12) Patent Application Publication
(10) Pub. No.: US 2025/0353154 A1
(43) Pub. Date: Nov. 20, 2025

(54) Stapling Device

(71) Applicant: Signode Industrial Group LLC, Tampa, FL (US)

(72) Inventors: Dimitrios TAKIDIS, Dübendorf (CH); Benjamin HUBSCHMID, Buchs AG (CH); Samuel HOCHSTRASSER, Fällanden (CH); Michael WETTSTEIN, Lenzburg (CH)

(21) Appl. No.: 19/291,194

(22) Filed: Aug. 5, 2025

Related U.S. Application Data
(63) Continuation of application No. 16/600,057, filed on Oct. 11, 2019, now abandoned.
Application No. 16/600,057 is a continuation of application No. PCT/IB2018/000458, filed on May 3, 2018.

(30) Foreign Application Priority Data
May 3, 2017 (CH) 00591/17
May 3, 2017 (CH) 00592/17
May 3, 2017 (CH) 00593/17
May 3, 2017 (CH) 00594/17
May 3, 2017 (CH) 00595/17

(51) Int. Cl. B25C 5/02; B25C 5/15; B25C 5/16

(52) U.S. Cl. CPC B25C 5/0207; B25C 5/0285; B25C 5/15; B25C 5/1624; B25C 5/1637

(57) ABSTRACT

A stapling device has a housing including a contact surface and defining an ejection channel terminating in an ejection opening defined in the contact surface. An ejector is movable in the ejection channel between an upper position and a lower position. A magazine is removably attached to the housing and configured to, when attached to the housing and when storing one or more staples, position a first staple in the ejection channel. The magazine is removable from the housing via movement in a first direction followed by movement in a second direction. A drive is operably connected to the ejector and configured to move the ejector from the upper position to the lower position to, when the magazine is attached to the housing and storing the one or more staples, engage the first staple in the ejection channel and eject the first staple out of the ejection opening.

### PRIORITY CLAIM

This application is a continuation of U.S. patent application Ser. No. 16/600,057, filed Oct. 11, 2019, which is a continuation of and claims priority to and the benefit of PCT Application No. IB2018/000458, which was filed on May 3, 2018, which claims priority to and the benefit of: Swiss Patent Application No. 00591/17, which was filed on May 3, 2017; Swiss Patent Application No. 00592/17, which was filed on May 3, 2017; Swiss Patent Application No. 00593/17, which was filed on May 3, 2017; Swiss Patent Application No. 00594/17, which was filed on May 3, 2017; and Swiss Patent Application No. 00595/17, which was filed on May 3, 2017, the entire contents of each of which are incorporated herein by reference.

### FIELD

The present disclosure relates to a stapling device for driving staples into an object, and more particularly to a battery-powered portable stapling device.

### BACKGROUND

Certain known portable stapling devices (sometimes referred to as staplers or stapling tools) use a fluid, such as compressed air, to accelerate fasteners, such as staples, nails, clamps, and the like, to drive these fasteners into objects. Such staplers are used, for example, in the manufacture of furniture (for attaching coverings such as leather upholstery to furniture) or to close the flaps of cardboard boxes. Depending on the intended application, staplers may differ from each other in their basic design layout. But regardless of application, such staplers usually comprise a piston movable in a cylinder between an upper and a lower dead center. An element for driving fasteners is situated inside the line of movement of the piston and serves for making contact with and ejecting the fasteners that are introduced from a magazine into the drive track.

Moreover, some known portable staplers include pincer elements that bend the legs of staples after they are introduced into a cardboard box. Such staplers are used especially for the closing of the cover flaps of cardboard boxes. With this type of stapler, it is necessary to coordinate the ejection movement with the movement of the pincer elements to grasp the ejected two-legged staples with the pincer elements when they have already pierced the cardboard box and to bend the two legs of the respective staple in the direction of a base leg of the staple.

There are several issues with these known staplers. The magazine of certain known staplers cannot be easily managed on account of the housing part of the motor interfering with the magazine, such as by preventing a clear view of the magazine. With certain known staplers it is difficult to precisely place staples at desired positions. Certain known staplers only drive one staple per trigger press, which leads to a slow work pace. Certain known staplers provide display and control elements that are not operator-friendly. Certain known staplers do not have an operator-friendly, quick way to clear jammed staples from the ejecting channel.

### SUMMARY

The present disclosure provides various embodiments of staplers that solve one or more of the above issues. In certain embodiments, the stapler of the present disclosure includes a housing assembly with a main housing section and a handle section that extends away from the main housing section. An ejector device is arranged in the main housing section and used to accelerate a fastener and to eject the fastener from an exit opening of the housing assembly. The stapler also includes a magazine assembly for holding a supply of staples, a driving device for the ejector device, a power supply device powering the drive device, and a trigger activatable to cause the driving device to move the ejector device to accelerate and eject at least one fastener from the exit opening.

In certain embodiments, the stapler includes an electric motor arranged in the handle section and oriented so its axis of rotation does not run parallel to a longitudinal axis of a path of acceleration of the ejector. This provides better access to the magazine without situating the magazine in a different place or altering its design. Surprisingly, the access to the magazine can be significantly improved in that the electric motor is situated not just at a greater distance from the magazine than previously. Thanks to the integration of the electric motor in the handle section of the housing the motor can be accommodated in a portion of the housing that needs to be present anyway for reasons other than to hold the motor. It is thus possible to avoid a separate housing section of the stapler (required only for the motor) and the associated weight thereof, and the handle may be used for an additional purpose.

This also results in a surprising ergonomic improvement, since the weight of the motor and possibly a gearing, including the articulation or attachment of the drive to an ejection or outlet mechanism, is arranged in or at least near the handle. Thus, the weight resulting from the motor and from the other components of the motor associated with the motor creates little or no torque about the place where the operator is holding and handling the stapler during its use. Thus, the operator need expend less force to handle the stapler and does not become fatigued as quickly. In one embodiment, at least a portion of the motor can be arranged directly in and/or beneath the area of the handle section with which the operator grabs the handle section by his hand and thereby holds the stapler.

The mentioned benefits can be further enhanced when a gearing (such as planetary gearing) switched in after the motor, especially for speed reduction and torque boosting, is likewise arranged in the handle section of the housing (or at least in its immediate proximity or in its area).

In certain embodiments, the power supply device is an interchangeable electric storage battery that can be installed in a receptacle of the stapler arranged at one end of the handle section of the housing and from which it can be removed. Thanks to this location of the arrangement of the storage battery, at most only a slight torque is required for the handling of the stapler, also due to the storage battery, so that it is possible to handle the stapler with only slight exertion of force. In one further embodiment of the stapler, it may be provided in an arrangement of the storage battery on the handle section of the housing that at least one, and in some embodiments all, required electric power supply lines from the storage battery to the motor are arranged solely in the handle.

In one embodiment, the electric motor situated in the handle section of the housing can be a brushless direct-current motor. The absence of brushes in the motor, which are prone to wear and tear, not only results in longer service life and no need for maintaining the motor, but also a smaller size of the motor and thus the possibility of designing the handle section solely in terms of ergonomic standpoints, and not so as to be able to accommodate the motor in the handle. The aspect of using a brushless direct-current motor as the drive for a portable mobile stapler for industrial use in the field of production and packaging with which staples are ejected may also have independent significance beyond other aspects of the present disclosure, especially—but not exclusively—independent significance in connection with a stapler.

A favorable ergonomic design of the stapler may also be achieved in certain embodiments in that the axis of rotation of the electric motor in relation to an acceleration path of the ejector for ejecting a staple is an angle chosen from a range of 60° to 120°, preferably with an angle of at least approximately 90°. Further, the two axes in certain embodiments intersect. However, it may also be provided that the two axes are spatially set off from each other. In this case, the mentioned angle between the two axes results by projecting the one axis in the direction onto the other of the two axes.

Moreover, it has proven to be favorable for the power supply device to be situated in the area of one end of the handle, in certain embodiments at the free end of the handle. If, in one especially embodiment, the power supply device is chosen to be an interchangeable storage battery, which can be arranged by way of a quick connection, for example a detent or a snap connection, on the stapler, then a receptacle for such storage batteries can be provided at the free end of the handle section of the housing. An electrical contact between the receptacle and the storage battery can be accomplished by contact elements integrated in the receptacle. This achieves an especially short wiring between the power supply device and the electric motor. This facilitates both the assembly of the stapler and possible repairs. A short wiring furthermore results in a slight electrical resistance of the wiring, which reduces electric losses and increases the energy content in the storage battery that can be utilized for stapling processes. Furthermore, the weight of a storage battery at the free end of the handle section results in better balancing of the stapler. The weight of the storage battery also acts as a counterweight to the ejection mechanism or ejector device of the stapler.

Certain embodiments of the stapler simplify filling of the magazine by including a fill level display or a fill level signal device provided for signaling a supply of staples contained in the magazine. Since in this way it is possible for an operator to recognize or perceive whether the magazine is about to run empty, it is possible to avoid an unforeseen emptying of the magazine.

Staples for filling a magazine are usually offered as staple blocks containing a particular number of staples glued together. These staple blocks have a particular length that depends on the number of staples and the size of the staples. In one embodiment, a marking may be provided on the magazine in addition to the fill level display, being at least approximately the length of the staple blocks suitable for the stapler. Once the fill level display reaches the marking, there is sufficient room available in the magazine to be able to add a new staple block to the magazine. Depending on the length of the magazine and the length of the staple blocks, it may be provided that the marking, as seen from the end of the magazine, is located approximately at the height of an integer multiple of the length of a staple block. If the marking is reached by the fill level display, an optically perceptible signal is sent that a number of staple blocks can be added to the magazine, corresponding to the integer multiple (N=1, 2, 3 etc.). The fill level display and the marking thus simplify the filling of the magazine in each case as full as possible once more as it comes toward the end of its staple supply. In this way, the work cycles between two filling processes can be as long as possible, so that the number of nonproductive filling processes can be reduced to a minimum.

Certain embodiments of the stapler improve the operator's ability to precisely place staples in predetermined positions by including at least one light-emitting device arranged in the housing assembly and situated such that its emitted light contains optically perceptible position information on U-shaped staples that can be ejected by the stapler. Hence, the present disclosure basically proposes using light to provide the operator with at least information about a position where the stapler can eject a staple, especially a substantially U-shaped staple, on account of its momentary orientation in space. With this knowledge, the operator can better orient the stapler than heretofore, such that a staple during a stapling process can also be placed in an object at the designated location.

In one embodiment, at least one light-emitting device can be provided, with which a directed light beam can be emitted from the housing in the direction of an object. With a directed light beam, especially precise position information can be displayed and relayed. The light-emitting device may send out directional light beams in the form of lasers, for example.

In another embodiment, the light beam may contain optically perceptible position information about a plane in which a staple plane of ejectable staples extends. A plane of staples here can be understood to mean in particular a plane of symmetry of the U-shaped staples that extends through the middle of the base leg and parallel to the two side legs of the staples. Such information may be advantageous especially but not solely in connection with the processing of cardboard boxes, in which two foldable cover flaps are to be joined together by way of one or more staples to form a cover of the cardboard box. With such a light beam, the light beam of the stapler can be aligned with a joint between the two cover flaps, thus ensuring the placing of the stapler in a nominal position in which in each case one leg of the respective staple will be placed in each of the two cover flaps.

In another embodiment the at least one light-emitting device is situated in the housing assembly and contains position information about a plane in which a staple plane of ejectable staples extends. Knowledge of the plane of staples, i.e., the plane in which the staple being ejected and the ejecting channel of the stapler is located, may likewise contribute to the precise setting of staples in objects. It is especially advantageous here if both the midplane and the plane of staples can be indicated with the aid of light-emitting device of the stapler.

In another embodiment, the stapler includes one or more different light-emitting device, with which light can be emitted in different colors, wherein the different colors in addition to the position information can also represent state information about the stapler in an optically perceptible manner. Thus, for example, the one or more light-emitting devices, besides the position information about the plane of ejection of the staples or other position information, may also signal with different colors for this respective position information whether the stapler is ready to eject a staple. This information may be especially significant if—as is provided in certain embodiments of the present disclosure—at least one particular condition must be fulfilled to enable an ejection. In various embodiments of the present disclosure, this may be for example the detection of the presence of an operator's finger on the trigger and/or the presence of an object in the area of the contact surface, which may be the exit opening for the ejecting of staples, or the contact between the contact surface of the stapler and an object.

In one embodiment, the stapler comprises only one light-emitting device that sends out a light beam directed in front of the device. The light beam lies in a plane that runs at least substantially perpendicular to the base leg of the respective staple being ejected, in certain embodiments through the middle of the base leg. This orientation of the light beam may also be defined as lying in a plane that is oriented at least substantially perpendicular to the plane of staples, which is subtended by the three legs of the particular nondeformed staple being ejected. This plane in certain embodiments runs parallel to the two free (not yet deformed) legs and has the same distance from them in each case. This light beam may be at least a laser light beam. Besides a point-like laser, especially of interest in this regard are linear lasers whose emitted light appears as a line on an object. The light beam in this case is a light plane emitted by the linear laser. Such lasers are already known in themselves and are offered by various manufacturers. In other embodiments, other light sources are also conceivable for this light beam, such as one or more LEDs.

In another embodiment, the stapler has only at least one light-emitting device, which indicates the staple plane formed by the three legs of the respective (not yet deformed) staple to be ejected. The at least one light-emitting device is in certain embodiments situated and shines in this staple plane and/or emits one or more light beams which are situated in the staple plane. In various embodiments one such light-emitting device is provided on either side of the exit opening for the staples laterally on the housing. These light-emitting devices may be LEDs. In other embodiments, other light sources are also conceivable for this at least one light-emitting device, such as one or more lasers.

In one embodiment, the stapler comprises both light-emitting devices, namely, at least one for signaling the position of the staple center and at least one, and in certain embodiments at least two, light-emitting device that indicates the position of the staple plane in an optically perceptible manner.

In another embodiment, at least one laser may be provided as the light-emitting device, and an adjusting device is provided for the light-emitting device, by which a direction (emission direction) of the directed light emitted by the light-emitting device can be changed and set. Since the oriented light beam of the light-emitting device is supposed to ascertain the most exact possible position information, it is necessary for the laser to be mounted as accurately as possible in its intended orientation and position in the stapler. But on account of manufacturing and/or assembly tolerances, the danger exists that the laser, especially a linear laser (line laser), does not occupy exactly the intended orientation and/or position in the holder. By way of the adjusting device described here, such inaccuracies can be corrected and the laser oriented as desired. In the case of a line laser in particular the course of the line formed by the laser light on an object can be altered and adjusted in this way. In other embodiments of the present disclosure, the described teaching can also be provided for light-emitting device other than lasers, for example, for a LED as the light-emitting device.

In one embodiment of the stapler, a conventional laser, especially a line laser, may be provided, and arranged in a housing. The housing of the laser should be provided with an outer surface that is circular in cross section and that is arranged in a holder in which the housing can rotate. In certain embodiments, an engaging element is provided on the housing, by whose activation the housing is rotatable in its holder. By a rotation, the laser can then be given a different orientation and thus a wrong orientation or arrangement can be at least partly corrected. The engaging element can be accessible for an activation not only during the assembly of the stapler, but also on the finally assembled and ready to use stapler. In this way, it is possible to perform a correction also afterwards and without disassembly of the stapler.

In one advantageous modification of this possible embodiment, the engaging element can at least partly enclose the outer surface and be accessible for a manual activation through a recess of the holder. In another possible embodiment, the engaging element may be elastically compressible and be arranged at least slightly clamped in the slotlike recess. Such an engaging element can be, for example, an O-ring arranged under stress on the housing. The stress should be such that, when the O-ring attempts to turn, no relative movement occurs between the O-ring and the housing, but instead the housing is carried along with the movement of the O-ring. Thanks to the at least slight clamping, it can be ensured that the light-emitting device cannot move unintentionally in its holder. A deliberate activation is required for a change in its orientation or position. In this way, the O-ring can be manually activated through the recess for a rotational movement, by which the housing of the light-emitting device is carried along and experiences a change in its orientation or alignment. Thanks to the slight clamping action by which the elastically deformable O-ring is arranged in the recess of the holder, the rotation occurs against an at least slight frictional force, making it possible for the light-emitting device to also be rotatable about very slight rotation angles and thus adjustable.

In other embodiments, the at least one triggering device of the stapling device includes a detection device for the detection of a body part, especially a finger, placed on the trigger. The detection device for the detection of a body part placed on the trigger may be situated in the activatable trigger or on the housing immediately alongside the activatable trigger. With such a sensor on the triggering device, an additional preventative measure may be achieved so that a staple may only be ejected if an operator has contact with the triggering device or at least one body part, such as a finger, is near the triggering device. This measure may be provided either by itself or as a condition needing to be fulfilled in addition to other conditions. A suitable detection device for this may be a proximity sensor, a photodiode or a photoresistor, for example.

Another condition for the performance of a stapling process may be a detection of the presence of an object. For this, at least one detecting device can be provided in the area of the contact surface of the stapler to detect the presence of an object beneath the contact surface.

In one embodiment, a stapler can thus also be provided in which a detection signal of the detection device can be sent to a control system of the stapler, and the control system is designed such that the detection signal is a requirement for enabling ejecting of a staple.

Finally, it has also proven to be especially advantageous when the detection signal for the presence of a body part can be utilized to switch on the at least one light-emitting device. Hence, the at least one light-emitting device can only be turned on when an operator also intends to make use of the stapler.

According to another aspect of the present disclosure, at least one of the above-described teachings may also be provided for a mobile strapping device for the strapping of packaged goods with a plastic or metal band, by which a loop of such a band is stretched and then a closure of the band loop can be placed on the stretched loop. In particular, at least one light-emitting device can be provided on the housing of such a strapping device, indicating on the strapping device an inserting position and/or a final position of a strapping band in the strapping device. Here as well, the light-emitting device can be arranged on the housing assembly of the strapping device such that its emitted light represents optically perceptible position information with which the operator is instructed how to situate the band in an intended nominal position in the strapping device.

The prevention of unintentional triggering of the stapler can be further enhanced by a further embodiment in which the trigger can be activated against the spring forces of at least two spring elements. In this way, it can be provided that, upon activation, the trigger is at first activated only against the spring force of the first spring and only during the further activation is the trigger activated against the spring forces of both spring elements. The triggering of an ejection also occurs after the spring force of the second spring element acts on the trigger against the activation of the trigger. Therefore, both spring elements are situated in the movement path of the trigger, but they only act for the first time on the respective trigger after different activation distances of the trigger have been traveled. Thanks to the suddenly increasing spring force on account of the additional action of the second spring element, the operator can be provided with the information that a triggering of an ejection is now imminent. Thus, an operator can better coordinate the ejecting of a staple.

In certain embodiments, the stapler increases the work pace when setting staples by including that at least one detecting device for detecting the presence of an object beneath the contact surface is provided in the area of the contact surface of the stapler at which at least one clinch element of the clinch device for the bending of staples emerges from the contact surface during a stapling process. This detecting device and the detection signal provided by it can be used to perform a stapling process with a staple even without subsequent activation of the trigger.

According to a second aspect of the present disclosure, at least two different operating modes of the stapler can be set, whereby in the first operating mode only one stapling process can be triggered by a (single) activating of the triggering device/trigger, such that only one staple can be ejected and its legs can be bent by way of the clinch device, and in a second operating mode multiple successive stapling processes can be triggered with one activating of the triggering device, such that each time one staple can be ejected and its legs can be bent by way of the clinch device. Alternatively to the mentioned second operating mode or supplementally as a third operating mode, in one embodiment a mode may also be provided in which further stapling processes are performed fully automatically in a given predetermined or variable predeterminable interval. An ejecting of staples in this latter mentioned operating mode may occur, for example, as long as or in each case when a particular release condition is present after a first ejection for further automatic ejections of this one automatic ejection series. One possible condition might be, for example, that the stapler has not been lifted off from the object but rather is being pulled or guided over the respective object with constant contact with the object for the automatic ejecting of a series of staples. Thus, it may be provided that the control system of the stapler will halt a series of automatically occurring staple ejections as soon as the stapler is lifted off from the object.

But as long as the presence of the stapler on an object is detected, without the stapler having been lifted off from the respective object, the automatically occurring ejection series will continue. Among other things, for this detection process the stapler may be provided with a releasing device which detects whether such a release condition is fulfilled.

Alternatively, it may also be provided that the presence of the stapler on an object must only be detected for the first ejection of such an automatically occurring series of ejections in an automatic mode and all subsequent ejections will then occur without such a detection.

As regards the number and/or time intervals of the ejections following the first ejection, these will occur in accordance with the predetermined values stored in the control system of the stapler. As regards the number of staples that can be ejected in this mode, a maximum value of ejectable staples may be specified, for example. It is also possible to significantly increase the work pace in this way. Thus, for example, to place a series of staples in an object, it is possible to merely pull the stapler set down on an object in automatic mode across the object and the staples will then be ejected in a predetermined or predeterminable time interval and driven into the object. In order that each operator can adapt the stapler to their own work pace and work style, in another embodiment a teach-in mode may also be possible for the automatic mode. In this mode, the stapler receives and memorizes the time intervals at which an operator manually activates the respective triggering device or the trigger two or more times in succession. In the mentioned possible embodiment of the automatic mode, staples are then ejected in precisely these time intervals.

With the teaching provided according to the present disclosure, a faster work style or a more pleasant and less fatiguing work style can be achieved for staplers outfitted with a clinch device.

In this way, for staplers which are equipped with a clinch device, it is furthermore possible to realize a semiautomatic mode for carrying out several consecutive individual stapling processes. In this semiautomatic operating mode, by a single activation of a trigger element it is possible to perform multiple consecutive stapling processes, including respective clinch processes, not requiring any manual activation of a triggering element by the operator for each of these stapling processes. There only needs to be a single activating of the triggering element. By contrast with the automatic mode, in the semiautomatic mode it may be provided, for the triggering of the staple ejections following the respective first staple ejection, that these will only occur if at least one other condition is fulfilled, as in the automatic mode, and devices are provided with which it can be detected whether the at least one condition for the semiautomatic mode is fulfilled. One possible condition may be, for example, that the stapler after a staple ejection must necessarily be lifted off from the object to perform the semiautomatic ejection of a series of staples when the trigger continues to be activated. Hence, it may be provided that the control system of the stapler will halt a series of semiautomatically occurring staple ejections once the stapler is lifted off from the object, but not set down again on the object with the trigger activated. Among other things, for this the stapler may be provided with a releasing device that detects whether such a release condition is fulfilled. The semiautomatically occurring ejection of staples can also be halted by ending the activation, i.e., in particular the pressing of the trigger.

In one embodiment there may be provided, in addition to the triggering device, a releasing device that provides a release signal to perform a stapling process to the control system in at least one of the two operating modes when a predetermined condition is fulfilled. In an embodiment, three possible operating modes are provided, namely, a manual mode, a semiautomatic mode, and an automatic mode, and in all three operating modes the releasing device can detect, to enable each staple being ejected, whether the next staple in each case is released for the ejecting. The releasing device may thus comprise at least one detecting device with which a presence of an object in the area of the contact surface can be detected, especially a contact between the contact surface and the object. It may be provided that a stapling process with a staple is only enabled upon detecting an object in the area of the contact surface by way of a detection device. In this context, non-contact releasing device, i.e., in particular detecting device working without contact, not needing the slightest mechanical contact to detect the presence of an object in the area of the contact surface.

However, the at least one detecting device for determining an object at the contact surface, especially a contact between the contact surface and the respective object, can in theory be based on various principles of detection. Thus, optical detection device are possible in particular, for example those having a light transmitter and a light receiver, wherein the object serves as a surface for reflecting the light emitted by the light transmitter which is to be detected by the light receiver. Likewise, mechanically working detecting devices are possible, such as microswitches. Further detecting device can be for example photoresistors, ultrasound distance sensors, proximity sensors, and other sensors that are able to ascertain the presence of an object.

One embodiment may provide at least two spaced apart detecting devices in the area of the contact surface. For example, it may be enough for objects that are not flat, such as curved objects, to enable a stapling process already if one of the two detecting device recognizes the presence of an object, especially a contact with the object, beneath this detecting device and provides a corresponding signal to the control system of the stapler.

It may also be provided that both of the at least two detecting device must provide an enable signal in order that a stapling process can occur. Insofar as one or more staples need to be driven into an object with a substantially flat surface in the area of the contact surface with bending of the legs of the respective staples, it is a significant contribution to misfire prevention that both detection devices must provide the presence of an object in the area of the respective detection device to enable a stapling process. In this regard, one embodiment has one detecting device of the two detecting devices situated each time at one of the two short side edges of the exit opening. Such an embodiment may ensure that both legs of a staple—and not just only one or even no legs—pierce the respective object.

The at least one releasing device provided in addition to the actual triggering device, being configured as at least one detecting device, has special advantages in connection with the semiautomatic mode which can be set on the stapler as one possible operating mode according to the present disclosure. With this detecting device, in one possible embodiment, it can be ensured that each stapling process actually occurring in the semiautomatic mode—after an initial triggering of a semiautomatic cycle of possible stapling processes—will only occur if the contact surface is also in fact situated on or at least directly above an object. Furthermore, the detection outcome ascertained each time in the semiautomatic mode for an object present in the area of the contact surface or a contact of the contact surface with an object can be utilized to enable and perform the respective stapling process. It may be provided here that it is necessary to detect at first the absence of an object in the area of the contact surface and then once more the presence of an object in the area of the contact surface for the subsequent performance of a stapling process, such as for each stapling process, in this cycle.

In various embodiments the ejecting of a staple will occur with a predetermined time delay, after the respectively given at least one condition for a releasing of the ejection is fulfilled. In one embodiment, there may be two conditions involved, namely, the detecting of a body part on the trigger and the presence of an object beneath the exit opening for the staples. If both objects are detected, the ejecting of a staple is enabled. However, in this embodiment the ejection will be triggered and occur with a time delay. It may occur with detecting device that they will wrongly detect a contact not yet actually existing as pre-existing as they are brought closer to an object, so that the ejecting of a staple occurs too early. The length of the delay is adjustable on the stapler. Alternatively, a fixed and unchangeable time delay may also be provided.

Certain embodiments of the stapler improve the operator-friendliness of the display and control elements via a display and control device having a membrane keypad device that comprises control elements as membrane keypad elements by whose activation one can adjust settings for the stapler and/or change the states of the stapler. The present disclosure thus proposes having a central display and control device on the stapler, encompassing as many as possible of the provided display and control elements, and configuring this as a membrane keypad.

In one embodiment of the stapler it may be provided that the stapler can be switched to a single ejection operating mode and a semiautomatic operating mode in which several stapling processes can be performed in succession after only a single activating of the trigger, wherein the display and control device comprises display device for signaling the operating mode which is switched on. In one embodiment, the display and control device may comprise at least one membrane keypad element for setting the operating mode.

Alternatively to the mentioned second operating mode or in addition as a third operating mode, in one embodiment such a mode may also be provided in which further stapling processes are performed fully automatically in a given predetermined or variable predeterminable interval as long as the presence of the stapler on an object is detected. Here as well the work pace can be significantly boosted.

To improve the ergonomics, it may be favorable to also provide on the membrane keypad device a display device for signaling a malfunction of the stapler. Insofar as the display and control device has a display device to indicate a charge state of a storage battery of an electrically operated stapler, it can be advantageous that the display device for the charge state can also signal a malfunction of the stapler, especially by a different display mode of the display device, especially by a change in color and/or by a change in a blinking mode.

In another embodiment, the stapler may comprise at least one light-emitting device arranged in the housing assembly that is situated such that its emitted light contains optically perceptible position information on the U-shaped staples which can be ejected from the stapler. Preferably, this light-emitting device can be switched to a ready state without emitting light. An actual turning on of the at least one light-emitting device may then occur only after another condition is fulfilled, for example, an operator has placed his hand or his finger on a particular position of the stapler. Thus, for example, a detecting device can be provided on or near the trigger to detect the hand or a finger, for example, a proximity sensor. An operating readiness display device arranged on the display and control device may signal the operating readiness of the light-emitting device, resulting in a turning on of the light-emitting device with no further separate switching process and the turning on of the light-emitting device will only depend on the fulfillment of at least one operating condition. Such a display device may be for example a display device of the membrane keypad device. Moreover, it may be a light-emitting diode.

An ergonomically favorable working position in which an operator while using the stapler can also notice and thus perceive a warning or malfunction signals at once may be accomplished in that the display and control device is arranged on a side surface, especially an inclined side surface, of the main housing section.

Certain embodiments of the stapler include a magazine device that can be inserted and removed in a more operator-friendly way, especially so as to be able to remove staples jammed in the ejecting channel as quickly as possible and return the stapler to an operational state once more.

Specifically, the stapler includes a quick lock provided with a guiding device, which enables the magazine to move in succession in two different directions, not parallel to each other, guiding it at least in substantially straight directions each time, during installation of the magazine on the carrier piece. The magazine when being removed from the stapler also can only be removed by moving the magazine along these two non-parallel longitudinal axes, but in reverse sequence and in opposite directions of movement. It is especially advantageous when the movements are in each case only possible along the two different axes or directions of movement for the removing and installing of the magazine. Since the movements for the installing and the removing are distinctly fixed and are also simple and quick movements, the magazine can be quickly removed and also quickly installed once more.

It may be especially favorable in this case to have a guiding device that enables the magazine to move in succession in two mutually perpendicular directions during a movement of installing the magazine. Such movements can be performed especially easily by an operator.

It may be especially advantageous for one of the movement directions to be oriented parallel or at least approximately parallel to the contact surface of the stapler. Especially if, during the removal process, the movement performed parallel to the contact surface is the first movement to be performed and it is possible for the second movement to also be performed with the stapler itself, the removal of the magazine can be done in a working position on an object without having to be lifted off from and removed from the object being worked upon.

In another embodiment, at least one of the two movements is bounded by an end stop. Preferably this will be the movement which is performed first, so that operator error can be prevented. In this way, the operator has no difficulty in passing from the first to the second movement at the proper place.

Moreover, it may be favorable to provide at least one swivel lever or quick lock lever of the quick lock that can swivel about a swivel axis running perpendicular to the contact surface. In certain embodiments, it should be possible to swivel in each case about in each case a swivel axis running perpendicular to the contact surface in the area of both sides of the magazine. This can realize an especially ergonomically favorable yet functionally secure quick lock.

In certain embodiments, the at least one swivel lever is arranged on a carrier piece of the stapler and interacts with a mating element of the magazine. In certain embodiments the mating element is a plate arranged on the magazine, which in the inserted state of the magazine bounds the ejecting channel on one side of the ejecting channel, a side of the ejecting channel at the magazine side.

The function can be further enhanced by an embodiment when the quick lock has self-locking device, which prevents the magazine from being removed without activating a releasing device designed to release the magazine. Preferably, the self-locking will further increase the holding forces of the magazine or further strengthen a form fit when such an attempt is made. One of several possibilities for a self-locking may be, for example, that the magazine turns a swivel lever—as the device of releasing the quick lock—against a release direction when attempting to remove the magazine without activating the release device.

### BRIEF DESCRIPTION OF THE FIGURES

FIG. 1 is a partly sectioned representation of a one example embodiment of a mobile portable stapler of the present disclosure.

FIG. 2 is a perspective representation of the stapler of FIG. 1.

FIG. 3 is a perspective partial representation of the stapler of FIG. 1.

FIG. 4 is an exploded partial representation of the stapler with its guide for a bayonet type arrangement and guidance of a magazine on the stapler.

FIG. 5 is a representation per FIG. 4 during the inserting of the magazine into the stapler.

FIG. 6 is a representation per FIG. 5 with the magazine in its end position.

FIG. 7 is a representation of the stapler from underneath, while inserting a magazine.

FIG. 8 is a representation per FIG. 7, with a further inserting of the magazine.

FIG. 9 is a representation per FIGS. 7 and 8, with the magazine in its end position.

FIG. 10 is a representation per FIG. 9.

FIG. 11 is a representation per FIG. 10 with a beginning removal of the magazine from the guide.

FIG. 12 is a representation per FIGS. 9 and 11 with a further removing of the magazine.

FIG. 13 is a longitudinal section through the stapler of FIG. 1 with a blocking device for the ejector.

FIG. 14 is the blocking device of FIG. 13 in a release position.

FIG. 15 is the blocking device of FIGS. 13 and 14 in a blocking position.

FIG. 16 is a perspective representation of the blocking device with a pawl in the blocking position.

FIG. 17 is a perspective representation of the stapler of FIG. 1 with a marking device arranged on the magazine device.

FIG. 18 is the marking device as the staples are further consumed.

FIG. 19 is the marking device with nearly all staples consumed from the magazine.

FIG. 20 is a side view of the stapler with a light beam of a light-emitting device as a positioning aid.

FIG. 21 is a sectional representation of the stapler of FIG. 20.

FIG. 22 is the light-emitting device of FIGS. 20 and 21 in a holder of the stapler.

FIG. 23 is a sectional representation of the representation of FIG. 22.

FIG. 24 is the stapler with two light beams emerging at the side of the stapler from two further light-emitting devices in a front representation.

FIG. 25 is the representation of FIG. 24 with a rear view.

FIG. 26 is a perspective representation of two light beam planes oriented perpendicular to each other from two light-emitting devices of FIGS. 20-25.

FIG. 27 is a sectional representation of the front end of the stapler with the representation of two light-emitting devices emitting light planes aligned with each other.

FIG. 28 is a sectional representation per FIG. 27 of alternative light-emitting device and with two light shafts.

FIG. 29 is a side view of the representation of FIG. 28.

FIG. 30 is a head area of the stapler in a partial representation with a display and control device provided on the stapler.

FIG. 31 is a sectional representation of the stapler with a trigger and two spring elements counteracting the operating force of the trigger.

FIG. 32 is a partial representation of FIG. 31 with the trigger in an early stage of activation, and with the two spring elements, one of them lying against the trigger and the other one spaced away from the trigger.

FIG. 33 is a representation per FIG. 32 with the trigger in a later stage of its activation, in which both spring elements lie against the trigger.

FIG. 34 is three front views each with a stapler, being provided with two mechanical detecting devices (contact switches) for the detection of an object in the area of a contact surface, the detecting devices being shown in different detection states in two partly sectioned representations.

### DETAILED DESCRIPTION

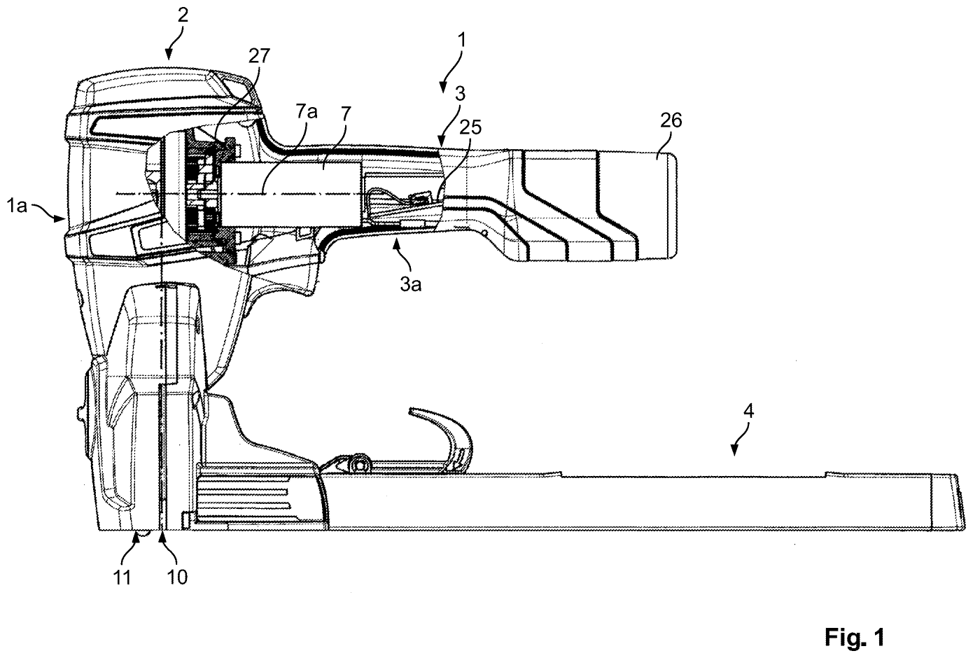

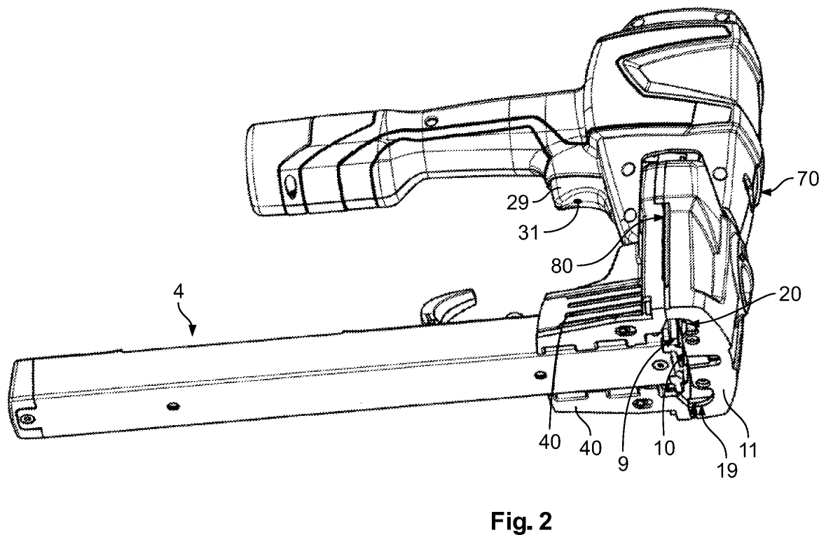

FIG. 1 shows one example embodiment of the stapler of the present disclosure as a portable electrically operated stapler 1, as is provided in the industrial or commercial field for the driving of fasteners, especially staples, into surfaces. The electric energy provided is used to drive out or eject staples. The housing comprises a main housing section 2 and a handle section 3, as will be further explained below. On the main housing section 2 there is arranged a removable magazine device 4 in which a supply of staples can be held. Inside the main housing section 2 is arranged an ejecting mechanism 6, which contains an ejector 8 driven by a motor 7, which in its acceleration path strikes against the foremost staple from the magazine 4, accelerates it, and pushes it out from an ejecting channel 9 and its exit opening 10. The exit opening 10 is situated in the area of a substantially flat contact surface 11 by which the stapler 1 is placed on the item or object to set a staple in the respective object with the stapler 1 in a motor driven manner.

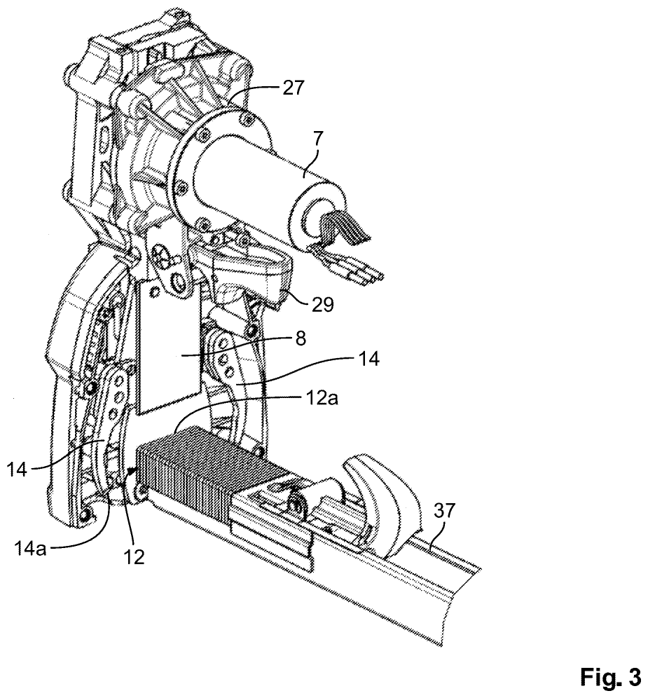

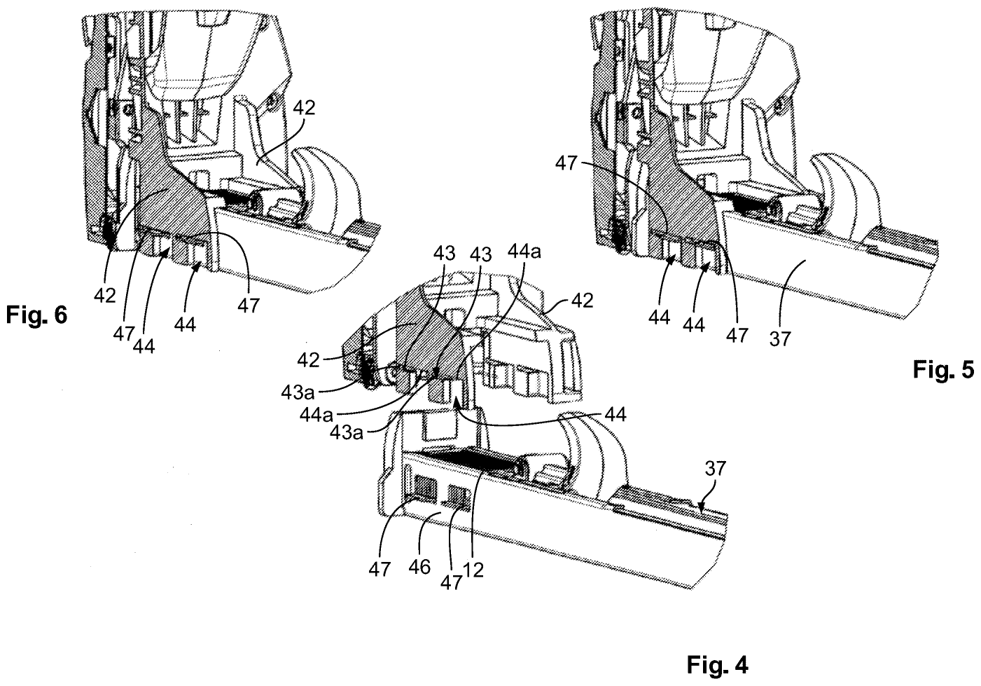

In this example embodiment, the stapler is used for the closing of cardboard boxes. It therefore comprises two so-called clinchers 14 (FIG. 3) that are synchronized in the movements performed by them with the movement of the ejector 8 and are driven in their movement into the cardboard box to bend the two legs of the respective staple in the direction of a base leg of the staple.

The housing may in certain embodiments be made from a castable or injection moldable plastic and it has two halves that can be put together. Each housing half thus has a portion of the main housing section 2 and a portion of the handle section 3.

The ejecting mechanism 6 situated in the main housing section 2 comprises a rotation element driven in rotation by the motor 7, being equipped with an eccentric cam. The cam is led in a slide of a straight-moving lifting element. The lifting element is led in a straight line so that it performs in each case a straight movement between an upper and a lower dead center, at which a reversal of the direction of movement occurs each time. The slide for the cam provided on the lifting element has a first slide segment running at a slant to the lift axis and an adjacent second slide segment running at least substantially perpendicular to the lift axis.

On the lifting element there is arranged a transmission rod by one of its ends, its other end being arranged on a guide element likewise led in the lifting direction. At the lower end of the guide element is situated the ejector, which together with the lifting element and the guide element executes an oscillating movement between the upper and the lower dead center of its movement. The ejector in its motor driven path is designed to make contact with the most forward staple of the staple supply located in each case in the ejecting channel by an end of the ejector facing away from the guide element and by the end face that is provided here.

Furthermore, linked to the guide element are two clinchers 14 that can swivel by a lever gearing 28. Each of the clinchers 14 has at its free end a blade 14a that penetrates into the object, here the cardboard box, during an ejection stroke of the ejector 8 by the swiveling movement of the respective clincher 14 and bends one of the two U-legs of the staple 12 in the direction of the base leg of the staple 12, thereby fixing the staple 12 against being simply pulled out from the cardboard box. Usually a stapler of this kind is arranged by its contact surface 11 on the cardboard box so that one leg of the staple 12 pierces one of the two foldable flaps of the cardboard box by which the cardboard box is to be closed. After the clinchers 14 have bent the legs of the staple 12, the clinchers 14 are swiveled back out from the cardboard box during the upward stroke of the guide element and the link element on the same path taken to arrive in the cardboard box and at the underside of the two flaps of the cardboard box. The downward and upward stroke movements of the link element thus follow the same straight path, but in reversed movement direction. The movements here occur along a common longitudinal axis, situated at the center of the guide channel of the link element.

According to the present disclosure, the ejecting mechanism 6 is motor driven, namely, by an electric motor in the present case. For this, a brushless direct-current electric motor 7 is situated in the handle section 3. By handle section 3 may be understood here the section of the housing that is designed to be grasped by the hand of an operator when he is using the stapler and guiding it by hand. This electric motor 7 in the present case is situated, at least by one segment of its longitudinal extension, inside the handle section 3 roughly in a place where the handle section has a grip 3a on its outside, designed and intended for the placement of the operating hand and fingers of the operating hand of the operator. In the area of the grip 3a, the operator grasps the handle section 3 and in this way can activate in ergonomically favorable manner a trigger 29 situated in the area of the grip 3a with his index finger. The trigger 29 is thus located immediately next to the motor 7 and the power board 25. By activating the trigger 29, the ejection of a staple can be set in motion.

Furthermore, a power electronics board 25 is located in the handle section 3 and is designed to control the motor 7 and to regulate the motor current. At the handle section 3 there is furthermore provided in the area of its free end a receptacle for an insertable and removable rechargeable storage battery 26. In the exemplary embodiment, the power electronics board 25 is located between the storage battery 26 and the electric motor 7. The necessary wiring 30 between the storage battery 26 and the power electronics board 25 and that between the power electronics board 25 and the electric motor 7 is likewise located in the handle section 3 of the housing.

As can be seen from FIG. 1, the axis of rotation 7a of the electric motor is oriented at least roughly parallel to the contact surface 11 of the stapler. As can likewise be seen in FIG. 1, the axis of rotation 7a of the electric motor is oriented at least roughly, in certain embodiments as exactly as possible, perpendicular to the longitudinal axis 13 of the guide or ejecting channel for the staples, and the straight movement axis 13 of the lifting element. The electric motor is attached to a planetary gearing 27, by which the respective motor speed is reduced, i.e., slowed down. The axis of rotation of the planetary gearing 27 connected to the motor rotation axis 7a at the output side of the gearing is aligned with the motor rotation axis 7a. The drive motion at the output side of the gearing drives the crank of the ejector mechanism and via the ejector mechanism 6 also the ejector 8 and the clinchers 14. The motor rotation axis 7a has approximately the same distance from the contact surface 11 as a point of application of the motor rotational movement from the gearing 27 or electric motor 7 to the ejecting mechanism 6.

Certain embodiments of the present disclosure are provided with a detection device 31 for the detection of a body part, especially a finger, placed on the trigger 29. This detection device 31 can be arranged either on the trigger 29 directly or on the housing of the stapler in direct proximity to the trigger 29. The detection device for the detection of a body part arranged on the trigger may be a proximity sensor, a photodiode, or a photoresistor. By way of a signal cable laid in the housing, a detection signal of the detection device can be taken to a control system of the stapler, the control system being designed such that the detection signal is a prerequisite for enabling the ejecting of a staple.

Finally, the trigger 29 can in certain embodiments be activated against the spring forces of at least two spring elements 17, 18. When the trigger 29 is activated, this occurs at first only against the spring force of the first spring 17 and only during the further activation of the trigger does the second spring 18 also act with its spring force against the trigger 29. As soon as the second spring 18 on account of a further activation path of the trigger 29 presents its spring force also as a compression spring against the further pressing of the trigger 29, the spring forces of both spring elements 17, 18 are then acting and the trigger now has to be activated against both spring elements 17, 18.

In the area of the contact surface 11 of the mobile portable stapler there is located a detecting device 19, 20 on either side next to the exit opening 10, with which the presence of an object directly underneath the contact surface 11 and thus beneath the exit opening 10 can be detected. Thus, these two detecting devices 19, 20 (sensors) are supposed to determine whether the stapler is arranged on an object into which a staple 12 can be delivered. In certain embodiments both detecting devices 19, 20 detect the object and must each provide a corresponding signal to the control system in order for the control system to enable the ejecting of a staple 12. In this way, one can prevent the ejecting of staples with no appropriate object being present. By having at least one detecting device 19, 20 at each end face of the exit opening 10, it can furthermore be detected whether the entire exit opening 10 or only a portion thereof is located on an object. The at least two detecting devices 19, 20 thus have a spacing from each other that is larger than the length of the exit opening 10. Also in this way it can be prevented that staples will be ejected and have only one leg in an object, thus not being able to fulfill their intended function.

The two detecting devices 19, 20 are in certain embodiments optical sensors. In other embodiments, the detecting devices are mechanical sensors or sensors based on other functioning principles. Besides other optical sensors, sensors may be suitable that emit light and detect a reflecting of the emitted light, for example. Such optical proximity sensors have long been available in many different designs, so that their construction shall not be further discussed.

Certain embodiments of a stapler according to the present disclosure in which mechanical contact switches are provided instead of optical detecting devices in the contact surface 11 are identified as detecting devices 119, 120. These detecting devices 119, 120 may at least be situated in substantially the same places of the contact surface 11 at which the optical detecting devices 19, 20 are provided.

Certain embodiments of the present disclosure are provided with the possibility of setting, besides a single shot mode of each time (only) one staple per activation of the trigger 29, also a semiautomatic mode and/or a fully automatic mode. This semiautomatic mode may be switched on and off at a display/control device of the stapler each time by activating a button (here a button of a membrane keypad 33, described below). By switching on the semiautomatic mode, after a onetime activation of the trigger 29 a stapling process is possible each time as long as certain conditions are fulfilled for the individual automatically occurring stapling processes. Such conditions may be, in particular, that both the detecting device 31 of the trigger 29 detect a finger and the detecting devices 19, 20 detect an object in the area of the exit opening 10. If such detection signals of the detecting devices 19, 20, 31 are absent, it may be arranged that no enabling will occur for a first staple 12. But if a first staple has been enabled and thus ejected on account of such detection signals, then no further activating of the trigger is needed in this operating mode for the output of further staples.

Thus, conditions for the triggering of a stapling process in the semiautomatic mode may be, for example, that it is ascertained by the detection devices that the contact surface is located on a surface of an object. After performing the first stapling process in semiautomatic mode, it may likewise be a condition for a following stapling process of the same ejection series in semiautomatic mode that the detection devices 19, 20 have detected an interim removal of the contact surface 11 from the object and then once more the presence of the object in the area of the contact surface 11. In other words, it must be detected that the stapler was lifted off from the object and set back down. It may likewise be provided that a further detection device is used to determine that an operator has placed a finger on the trigger, but without the operator having to activate the trigger. In other alternative embodiments, however, it may also be provided that a series of staple ejections can only occur in the semiautomatic mode if the trigger 29 is activated without interruption.

It is possible for detection devices, such as optical proximity sensors in particular, to signal the presence of an object already when the particular sensor is in the immediate proximity of the respective object, but no contact exists as of yet between the stapler and the object. To prevent staples from being ejected too early in the semiautomatic mode, i.e., at times when the stapler is not yet fully situated by its contact surface 11 on the object, a time delay after such detection signals may be provided for the respective staple ejection. The time delay may either be stored as a fixed time value in the control system or it may be adjustable by an operator on the stapler, especially adjustable from a time value from a range. Possible time delays may be for example values from a range of 5 milliseconds to 350 milliseconds, but in certain embodiments from a range of 10 milliseconds to 200 milliseconds. In the exemplary embodiment, a value of 50 milliseconds is provided.

Besides the manual operating mode in which each time an activation of the trigger is required for each individual staple ejection, there is finally alternatively or possibly in addition to the semiautomatic mode also a (fully) automatic mode. In this third operating mode of the stapler that can be set in place of the other two operating modes, after detection of the fulfillment of at least one enable condition and after activation of the trigger 29, staples can be ejected for as long as the trigger 29 remains activated or depressed and the contact surface 11 is present without interruption on an object. In this way, for example, it is possible and intended for the stapler 1 to be pulled across an object, each time there occurring the ejecting of a staple from a series of staple ejections after a certain time interval. As soon as the trigger 29 is released and/or the stapler is lifted off from the object, the control system halts the ejecting of further staples.

Finally, in conjunction with the automatic mode it may also be provided that the time interval between one staple ejection and the immediately following staple ejection can be changed. In one possible embodiment, this interval may be set on the stapler 1 by an operator by a corresponding entry as a value. Alternatively or additionally, in a further possible embodiment, it may be provided that the interval is dictated in a teach-in (learning) mode of the stapler. For this, the time interval during which an operator ejects two staples by way of the stapler can be memorized in an adjustable teach-in mode. This interval is then used for the automatic mode. In this way, the automatic mode can be adapted to the work style and work pace of an operator.

In the area of the contact surface 11, in the region of the two short side edges of the exit opening 10 of the ejecting channel 9, each time a detecting device 19, 20 is arranged on both sides for the detection of an object. With these detecting devices 19, 20 it is possible to determine whether the stapler is located by its contact surface 11 on an object and therefore a stapling process can be enabled. Detection signals of the detection devices 19, 20 are relayed to the control system of the stapler and used there to control the stapler. The detecting devices 19, 20 may work by various principles, for example, as mechanical or as optical detecting device.

In the figures, the stapler is shown with inserted magazine 37 in a slanted bottom representation. There has been installed in the magazine a supply of staples 12 that is pressed by a spring-loaded pusher 38 in the direction of the ejecting channel 9 of the stapler. The frontmost one of the U-shaped staples 12 is thus always present in the ejecting channel 9, in which it is grasped by the ejector 8 during its movement, accelerated, and forced out from the exit opening 10.

In this representation of the figures, a swivel lever 40 and its swivel axis 41 exist on either side of the magazine 37. The swivel levers 40 and their swivel axes 41 belong to a quick lock by which the magazine can be releasably secured to the stapler 1 and also removed by releasing the quick lock. Thus, a first and a second swivel lever 40 are located on opposite sides of the magazine, both of them able to swivel about their respective swivel axes 41. The two swivel axes 41 run parallel to each other and at least substantially perpendicular to the contact surface 11. Finally, the two swivel axes 41 are also oriented parallel to the longitudinal axis of the ejecting channel 9.

As is represented in the cross sectional representation of the figures, the main housing section of the stapler has two guide bodies 42 for the magazine 37, spaced apart from each other. Each of the two guide bodies 42 is provided with guide elements for the magazine, which is approximately rectangular in cross section. On their walls, the guide bodies 42 are provided with guide elements 43 for a movement of the magazine 37 parallel to the contact surface 11 and with one or more end stops, to limit this movement. In the exemplary embodiment, these guide elements 43 are recesses running parallel to the contact surface 11, here being slotlike recesses, in the guide bodies. Each time the ends of the slotlike recesses serve as end stops 43a in the exemplary embodiment.

In the exemplary embodiment, the slotlike recesses pass into rectangular recesses of the walls of the guide body 44. The likewise rectangular recesses 44 also serve as guide elements for a definite guided relative movement between the magazine 37 and the housing of the stapler. The upper end face wall boundaries 44a of the recesses 44 constitute the end stops here for the movement guidance by way of the recesses 44 in the direction perpendicular to the contact surface. Thus, as seen from the bottom open rectangle shape of the recess 44, each of the two substantially rectangular recesses 44 in the area of the upper end face wall boundary adjoins the slot running parallel to the contact surface 11 and in the direction of the ejecting channel 9 as a guide element 43. In certain embodiments described here merely as an example, each of the two guide bodies thus has two identical guide elements 43, 44 arranged alongside each other.

The magazine 37 is provided with two brackets 47 spaced apart and arranged one behind the other in the area of its side walls 46 near the ejecting channel. The brackets 47 project perpendicular from the outer surfaces of the side walls 46 and when a magazine 37 is inserted into the stapler 1 they have a substantially parallel orientation to the contact surface 11. The brackets 47 are spaced apart from each other and dimensioned such that they can be arranged in the recesses of the guide elements 43, 44 of the guide body and can be moved there along the respective longitudinal extension of the recesses—and only along these longitudinal extensions. To attach a magazine 37 to the stapler 1, the brackets 47 are introduced from the bottom open side of the guide elements 44, so that the brackets 47 are moved in the guide elements parallel to the contact surface 11 until the respective bracket 47 reaches the upper end (end stop) of the respective recess of the guide element 44. This movement direction is oriented perpendicular to the contact surface 11. Now the respective bracket 47 can be moved parallel to the contact surface 11 into the respective slotlike recess of the respective guide element 43 until the brackets 47 reach their respective end stop 43a at the same time. The slots of the guide elements 43 and the thickness of the brackets 47 are dimensioned such that the brackets 47 after reaching their end stop 44a in the respective guide element 44 are introduced into the respective slot of the guide elements 43 and can now perform a movement substantially parallel to the contact surface. When inserting a magazine 37, the first movement of the magazine 37, or that of its brackets 47, in the recesses of the guide elements 44 and the second movement of the brackets 47 in the slots of the guide elements 43 are thus oriented perpendicular to each other. For the removal of the magazine from the stapler 1, the slots are led out from the guide elements 43, 44, now in the reversed movement direction, but along the same path. It is possible both when inserting and when removing a magazine 37, to also move the stapler 1 instead of the magazine 37 along the described path. The relative movements between the magazine 37 and the guide bodies 42 of the stapler 1 are what matter.

In each of the two guide bodies 42, one of the swivel axes 41 is led through the respective guide body 42 on both sides in the area of the magazine 37 and a spring element 49 in certain embodiments configured as a compression spring is arranged and braced against the guide body 42. The respective swivel axis 41 is arranged with a spacing from the spring element 49 (compression spring) and has a smaller distance from the ejecting channel 9 than the respective spring element 49 of the same side of the magazine. Each of the swivel axes 41 runs at least substantially perpendicular to the contact surface 11 of the stapler and also at least substantially parallel to the longitudinal axis of the ejecting channel 9. The swivel levers 40 that can pivot about their respective swivel axis 41 can thus execute swivel movements about this axis, lying substantially in a swivel plane running parallel to the contact surface 11. The respective swivel axis 41 is also led through one of the swivel levers 40.

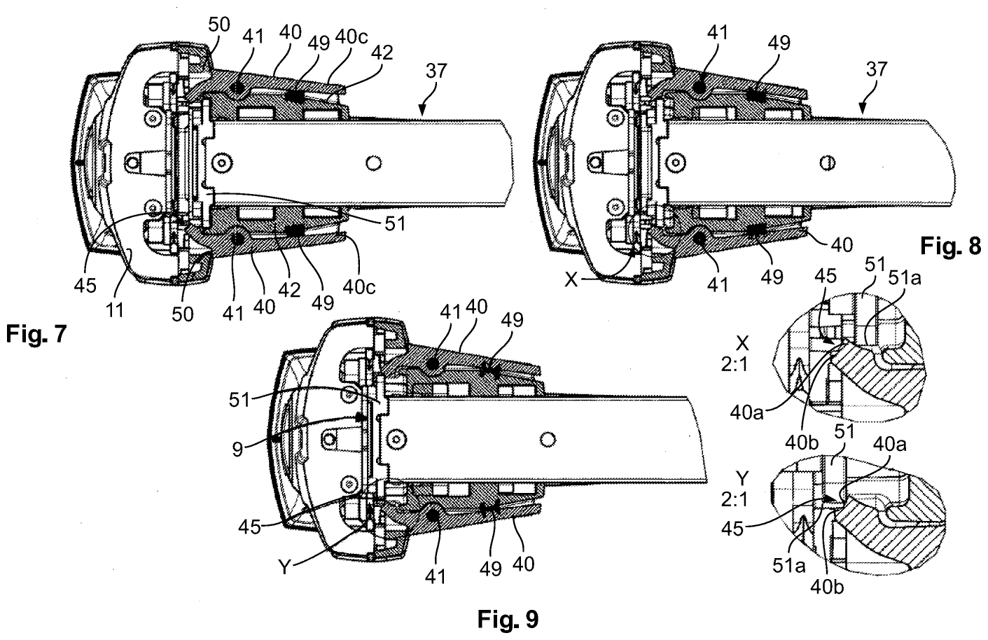

The respective guide body 42 is situated between the magazine 37 and the swivel lever 40 belonging to this side of the magazine. At its outer side, each of the swivel levers 40 has a shoulder 50. The shoulder 50 is provided for bearing against a surface of a carrier body of the stapler 1 and thus serves to limit the depth of insertion of the magazine 37 in the stapler. Furthermore, each of the two swivel levers 40 is curved by its end at the ejecting channel side in the direction of the magazine 37 and provided with a profiled end face 45 (FIGS. 7-12).

The stapler 1 has a rear plate 51 in the area of its magazine-side opening, which is also located in the area of the ejecting channel 9, which bounds the ejecting channel 9 at the magazine side when the magazine 37 has been inserted and is part of the magazine 37. The rear plate 51 extends on both sides beyond the rail of the magazine 37 in which staples 12 are stored. Side surfaces of the rear plate 51 are situated roughly at the height of the ends of the swivel levers 40 at the exit channel side. The end faces 45 of the swivel lever ends are each provided with two partial surfaces 40a, 40b making an obtuse angle, which interact with the respective side surface 51a of the rear plate 51.

To release the magazine 37 secured in the stapler 1 and remove it, for example on account of a staple jam or to refill the magazine 37, first of all the two swivel levers 40 have to be activated about their respective swivel axis 41 and against the spring force of the spring elements 49. In the case of an inserted magazine 37 locked at the quick lock, the rear sections 40c of the swivel levers 40 are at a distance from the respective guide body 42. These swivel lever sections 40c are pushed away from the guide body 42 by the spring element 49 in the form of a torque about the swivel axis 41. A resulting swivel movement of the swivel levers 40 is limited each time by an end stop of the shoulder 50 of the swivel levers 40 on the carrier body or on the housing of the stapler. An activating of the swivel levers 40 now results at first in a swivel movement about the swivel axis 41 against the spring force, so that the rear sections 40c of the swivel levers 40 come to bear against the guide body 42, as is shown in FIGS. 7, 8, 9. The profiled end faces of the front ends of the swivel levers 40 are lifted off by the rear plate 51 from their identical locking positions on the rear plate 51, in which the two partial surfaces 40a, 40b of the profiled end faces of the swivel levers 40, angled toward each other, thrust against an edge region of the end face of the rear plate 51. In this way, the magazine 37 is released for pulling out from the guide (guide elements 43, 44), and so the quick lock is loosened.

On the other hand, as long as the respective end face of the swivel levers 40 lies against the end face 51a of the rear plate 51 and the quick lock is not released by hand, the quick lock is locked with self-locking. A pulling on the magazine 37 has the result, due to the geometry of the front ends of the swivel levers 40, that the rear plate 51 has a tendency to swivel both swivel levers 40 about their swivel axes 41 against their direction of turning when loosening the quick lock. This results in an increasing of the holding forces exerted by the swivel levers 40 at the carrier side or housing side on the rear plate 51 at the magazine side.

After the quick lock has been loosened as described, the magazine 37 can be distanced from the housing with a movement running parallel to the contact surface 11. The direction of this movement is dictated by the slots of the guide elements 43 and the brackets 47 led therein. The movement is halted as soon as the brackets 47 strike against side boundary walls of the recesses of the guide elements 44. In this position, all the brackets 47 are situated with their entire longitudinal extensions inside the recesses of the guide elements 44, at their upper ends. By a movement of the brackets 47 inside the recesses of the guide elements 44 toward the open bottom end of the recesses or alternatively a movement of the recesses along the brackets 47, the magazine 37 can be entirely removed from the stapler. Thus, a simple option of removing the magazine 37 may be to place the stapler 1 lying against a base by its contact surface 11 and the bottom of the magazine 37 and to activate the swivel levers 40, which may also be called quick lock levers. After this, the magazine 37 is moved parallel to the contact surface 11 in a first direction as far as the end stop of the brackets 47. The stapler may then be lifted relative to the magazine, perpendicular to the contact surface 11, until the recesses of the guide elements 44 are removed from the brackets. The magazine 37 is now separated from the stapler 1 and freely accessible.

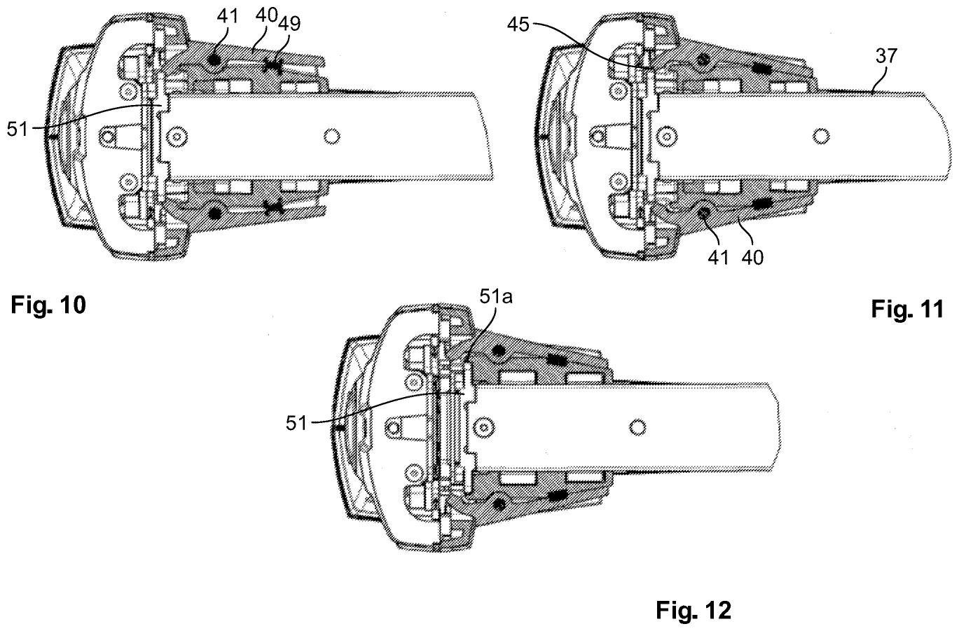

For the inserting of the magazine 37 into the stapler 1, the aforementioned movements between the magazine 37 and the stapler 1 can be performed now in reversed sequence and in reversed movement direction (FIGS. 10, 11, 12). The magazine 37 can be attached by its brackets 47 from underneath to the recesses of the guide elements 44. With a movement of the magazine 37 perpendicular to the contact surface 11, the brackets 47 can be introduced into the recess and moved as far as the first end stop. After this, the magazine 37 can be moved perpendicular to the first movement in the direction of the ejecting channel 9. The rear plate 51 arranged on the magazine 37 makes contact with ends of the swivel levers 40 at the ejecting channel side and swivels them against the spring force of the spring elements 49 about their respective swivel axis 41. The rear plate 51 in this way can pass by the back-swiveled swivel levers 40, whereupon the swivel levers 40 loaded by the spring elements swivel back into their locking position, now in the opposite swivel direction. Due to the acting spring force, the swivel levers 40 snap back, which may serve as a sign of a magazine 37 properly arranged in its end position for the operator. As can be seen in the enlarged representation of one of the figures, one of the partial surfaces 40a of the front end face of the respective swivel lever 40 gets in front of the rear plate 51 and locks it against a pulling out of the magazine 37. The other partial surface 40b of the front end face, on the other hand, lies against the side surface (end face) 51a of the rear plate 51 and in this way is prevented from further movement about the swivel axis. Thus, the swivel levers 40 remain in this position. Hence, besides the magazine 37, the rear plate 51 is also arranged in its intended nominal position on the stapler 1, in which it bounds the ejecting channel 9 at the magazine side.

To ensure the stapler cannot be triggered when no magazine is installed in the stapler, the stapler comprises a movable blocking device. The blocking device can be swiveled into the movement path of the ejector 8, so that the ejector 8 cannot execute a lifting movement. The blocking device can be situated in two end positions, whereby the blocking device in the first end position is situated outside the movement path of the ejector 8 and thus releases the ejector for its lifting movement to eject a staple. In the second end position, on the other hand, the blocking device is in the movement path and thus it blocks the ejector.

In the exemplary embodiment which is depicted, the blocking device is a swivelable pawl 55 arranged on a shaft 56 and that can pivot about the longitudinal axis of the shaft 56. The shaft 56 and its swivel axis are oriented perpendicular to the lifting movement of the ejector 8 and parallel to the base leg 12a of the respective staples 12 situated in the magazine. The pawl 55 has two legs 55a, 55b, one leg 55a being located on one side of the shaft 56, the other leg 55b being located on the opposite side of the shaft. The pawl 55 has a driving lug 57 on the leg 55a at its lower end, close to the exit opening 10. Furthermore, a compression spring 58 presses against the other leg 55b, which thereby tends to press the leg 55b in the direction of the ejector. If no other force is acting against the pawl 55, the force of the compression spring will swivel the pawl 55 with its leg 55b into a groove 8a of the ejector 8. In this end position, the leg 55b of the pawl 55 thus blocks the ejector against a movement in the ejecting channel 9.

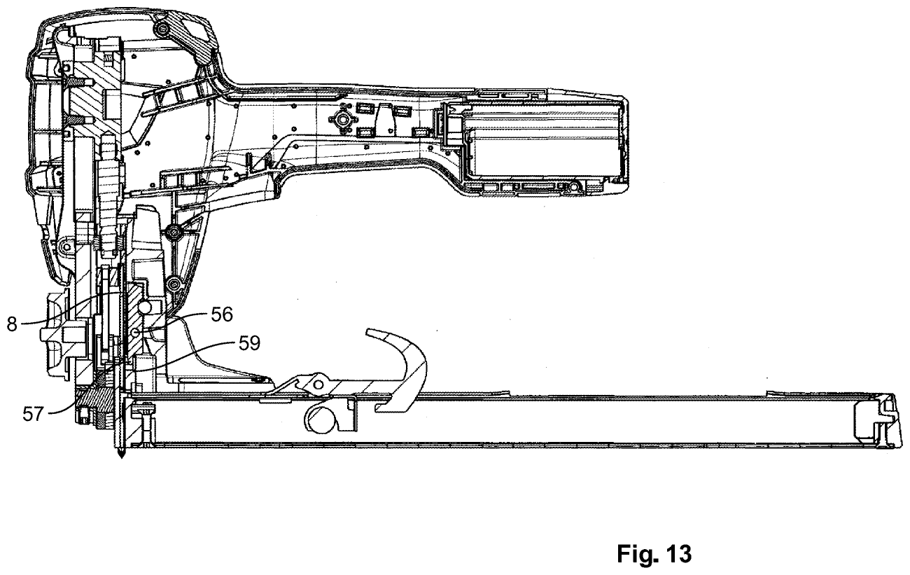

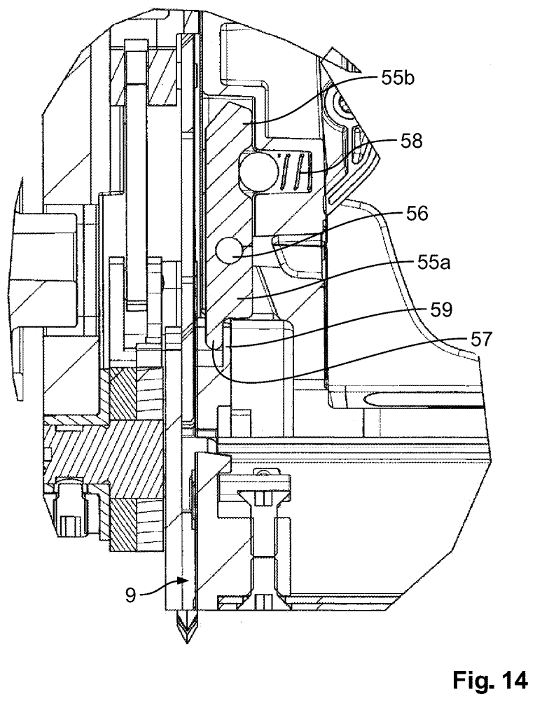

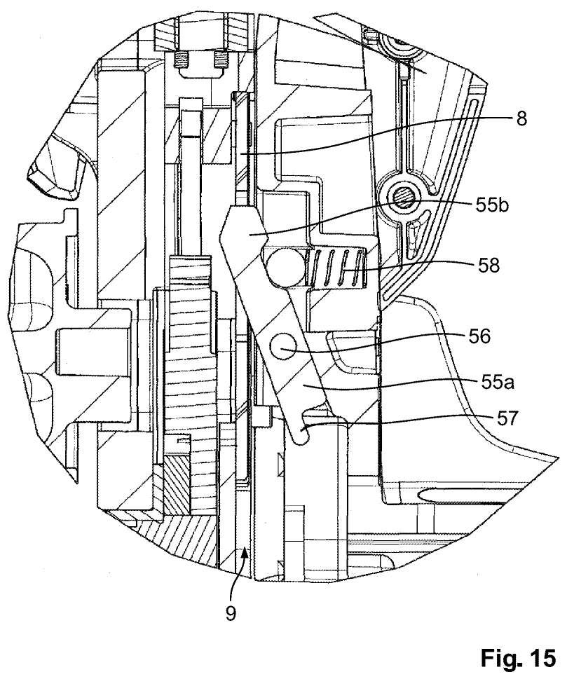

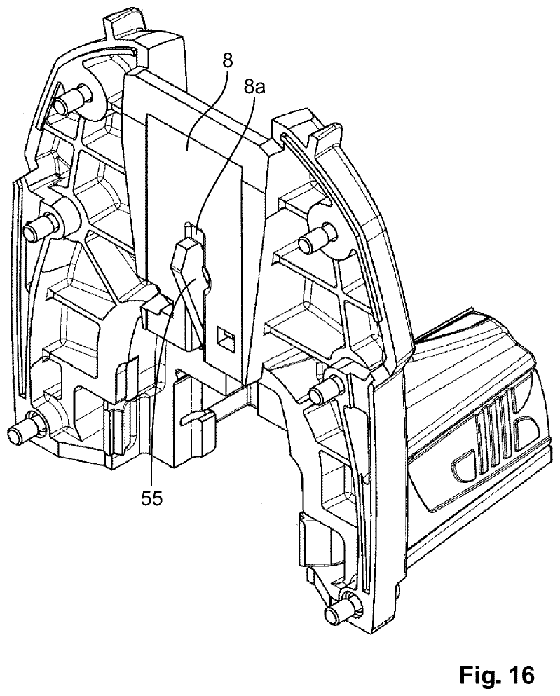

By inserting a magazine 37 into the stapler, a component 59 of the magazine pushes against the leg 55a of the pawl shortly before reaching the end position of the magazine in the stapler 1. During the movement of the magazine 37 parallel to its longitudinal extension, the component of the magazine engages the driving lug 57 of the pawl 55 and swivels the pawl 55 against the spring force of the compression spring, so that the leg 55b is swiveled out from the groove of the ejector 8 and thus also out from the movement path of the ejector 8. When the magazine 37 has reached its end position, it holds the pawl 55 by bearing against the driving lug 57 in a second end position, in which the pawl 55, in the representation of FIGS. 13, 14, is oriented substantially vertically and parallel to the ejecting direction of the staples. The pawl 55 in this second end position is situated outside the ejecting channel 9 and thus clears the ejector for an ejecting movement. When the magazine 37 is removed once more, it then again releases the driving lug 57 and thus the pawl 55. In this way, the pawl 55 can once again be moved into its end position in which it blocks the ejector 8 during the removal movement, on account of the force of the compression spring 58.

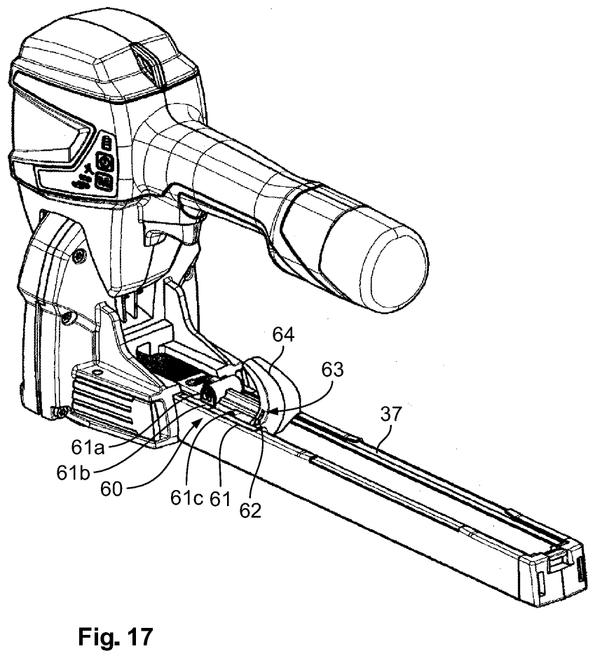

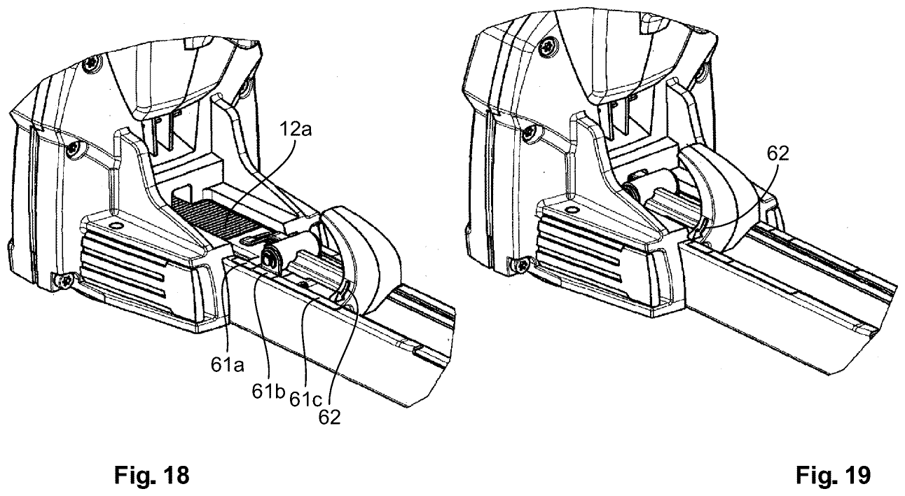

As can be seen from FIGS. 17, 18, the magazine is provided with a fill level display 60. For this, a marking 61 is placed on one or more stationary parts of the magazine 37, showing the degree of fullness of the supply of staples in the magazine. The markings for example may have optically perceivable differences along the direction of supply or stacking of the staples in the magazine, standing for a different degree of fullness and symbolizing that degree. The optical differences for example may be different colored partial markings 61a, 61b, and 61c. In particular, a minimum fill level marking at which the magazine needs to be filled again can be designated with a signal color, such as red, in particular signal red. Of course, other kinds of markings are also conceivable and possible, such as different geometrical shapes. An acoustic signal may also be provided, either in addition or by itself, for reaching a minimum fill level.

The magazine 37 furthermore has a display or indication device 63 which moves along with the stack of staples that is depleted during use, which shows the particular fill level of the magazine 37 with staples 12 at the markings 61. An especially favorable solution for this is a spring-loaded slide 64, with which the stack of staples 12 arranged in the magazine 37 is pushed in the direction of the ejecting channel 9 of the stapler 1, serving to display or indicate the fill level with the aid of one or more markings 61. A simple design form can, for example, be provided in that one end face of the slide 64, by which the slide rests against the stack of staples, indicates or represents the particular fill level at the markings. The solution realized in the exemplary embodiment calls for an arrow 62 arranged on the slide and pointing at the markings as the indication device 63. The arrow may be arranged for example on a handle piece of the slide 64, with which the slide can be moved in the magazine 37 also by hand, in particular it can be pulled back for the holding of staples.

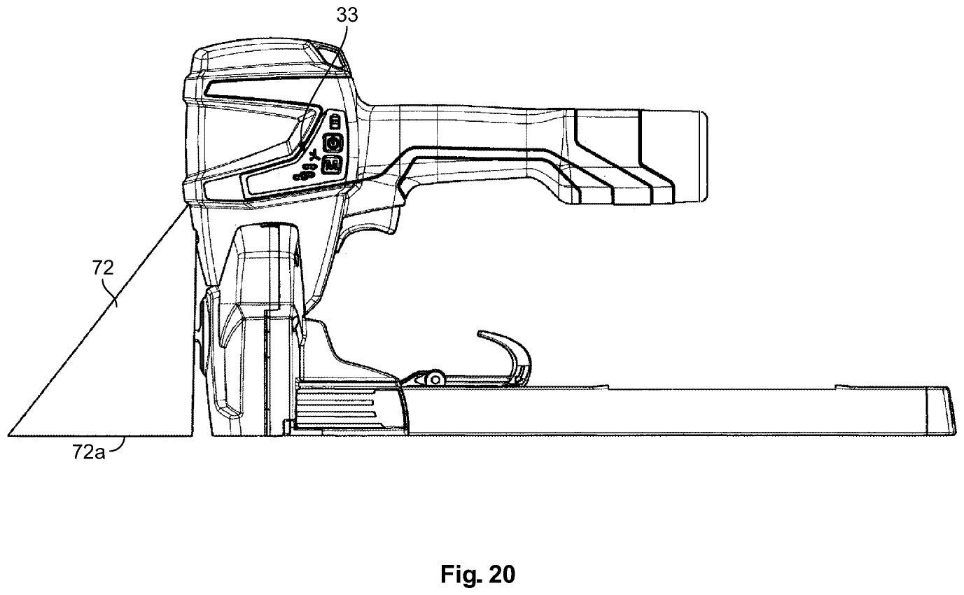

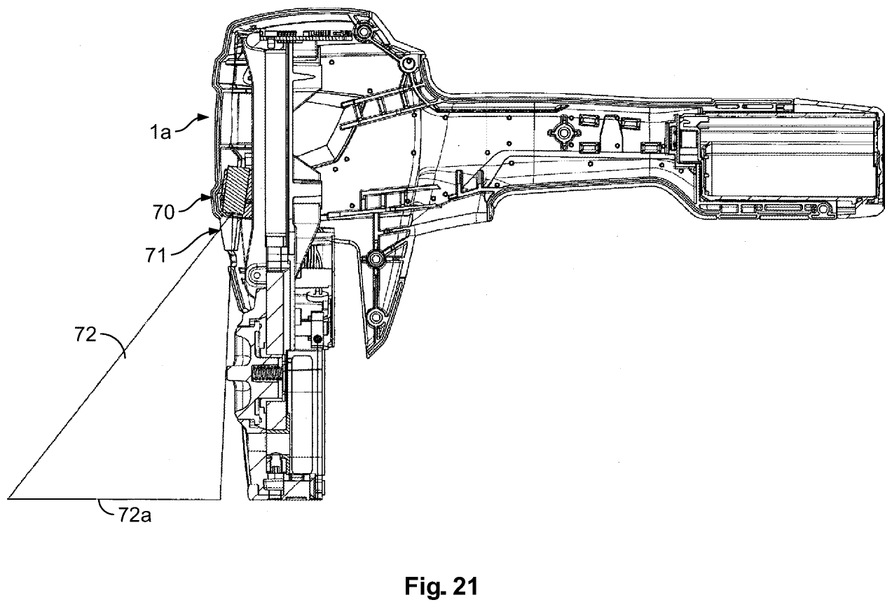

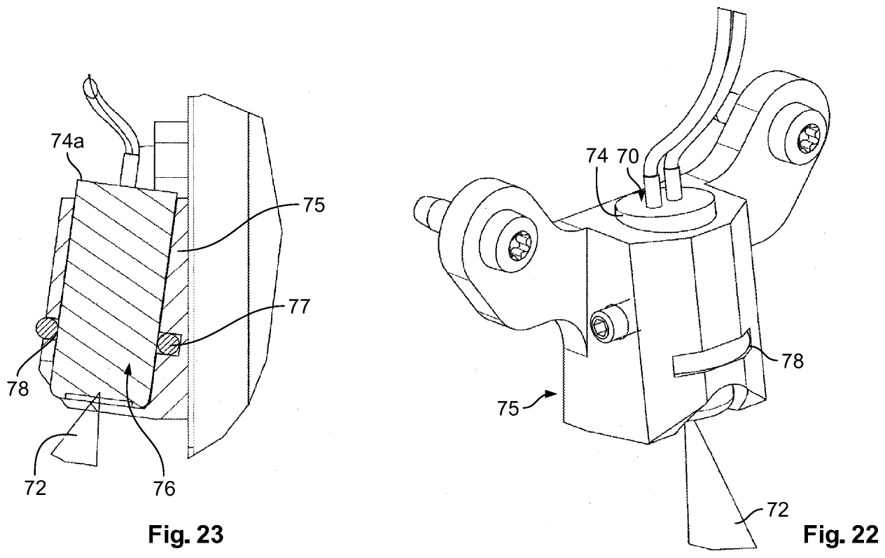

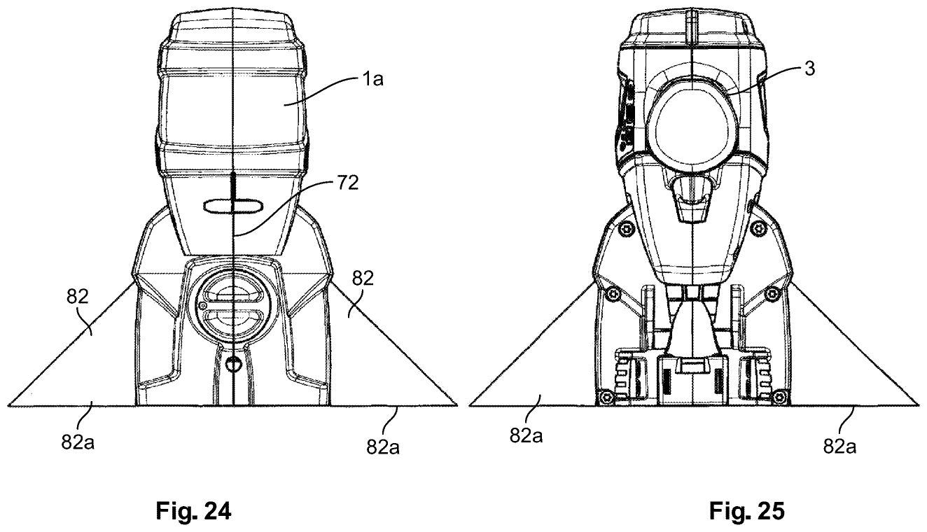

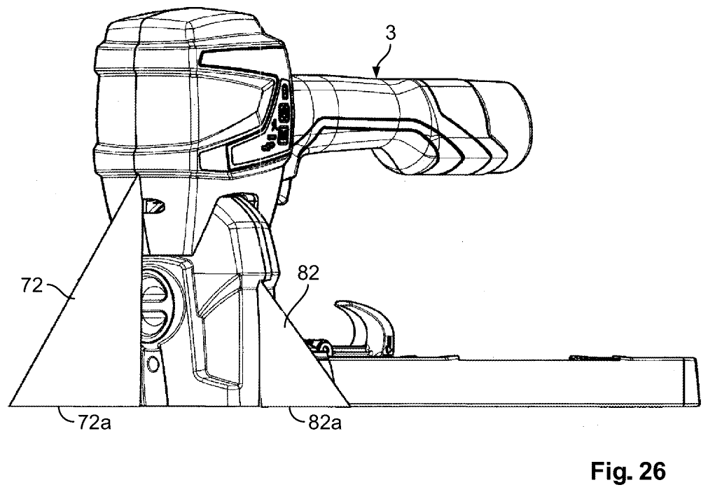

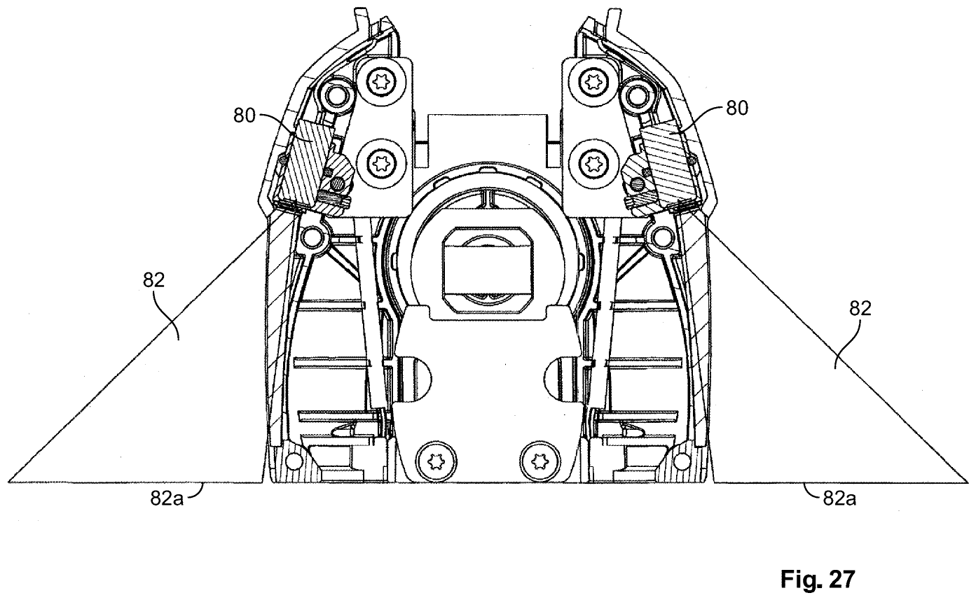

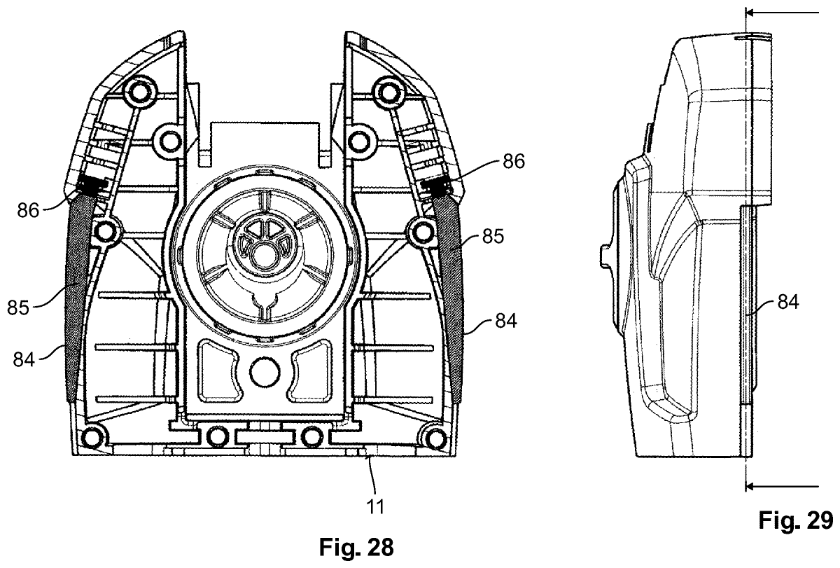

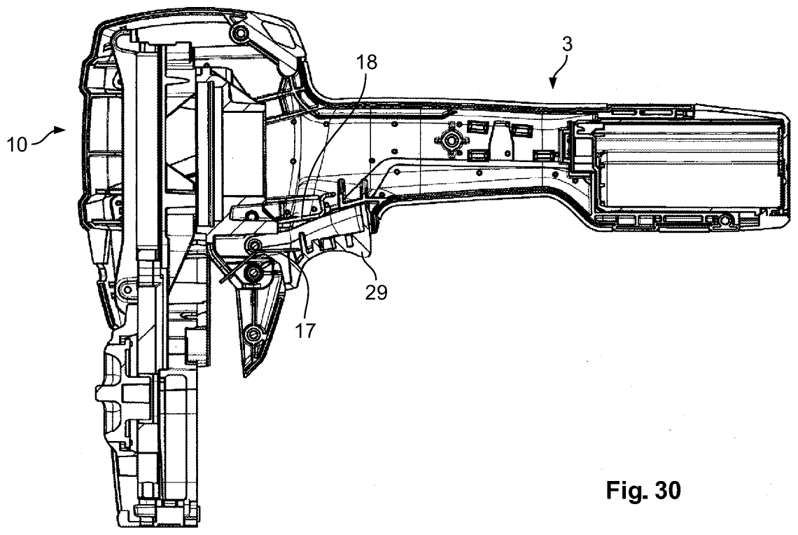

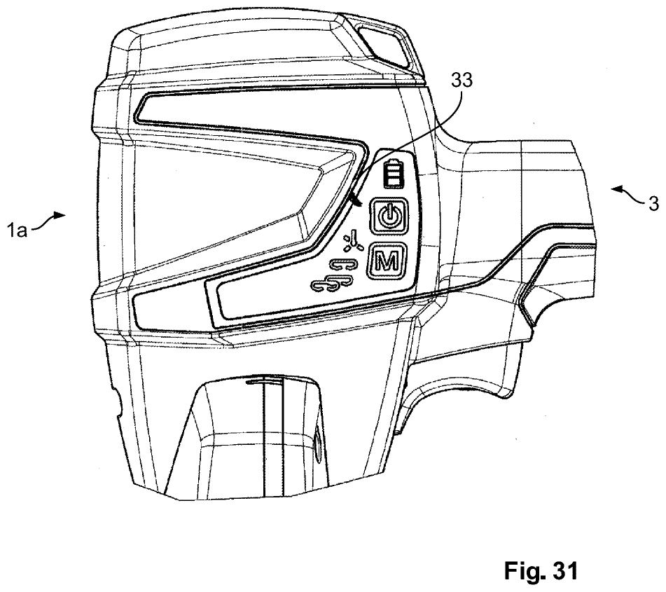

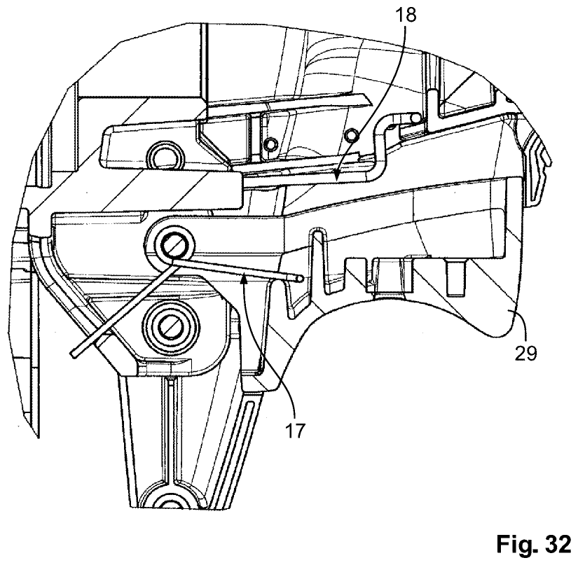

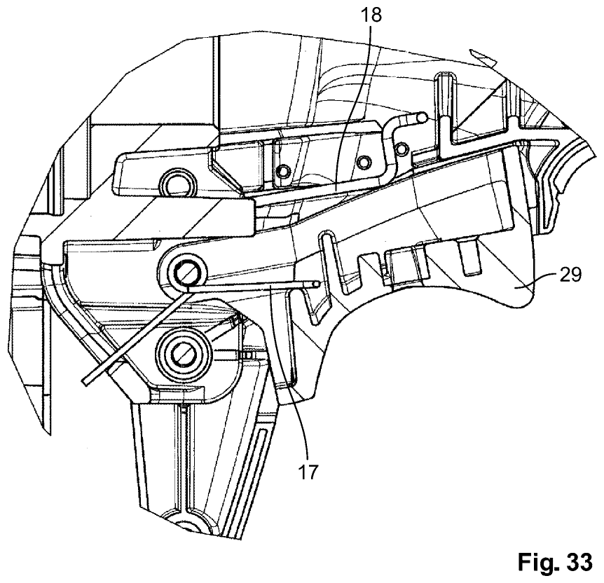

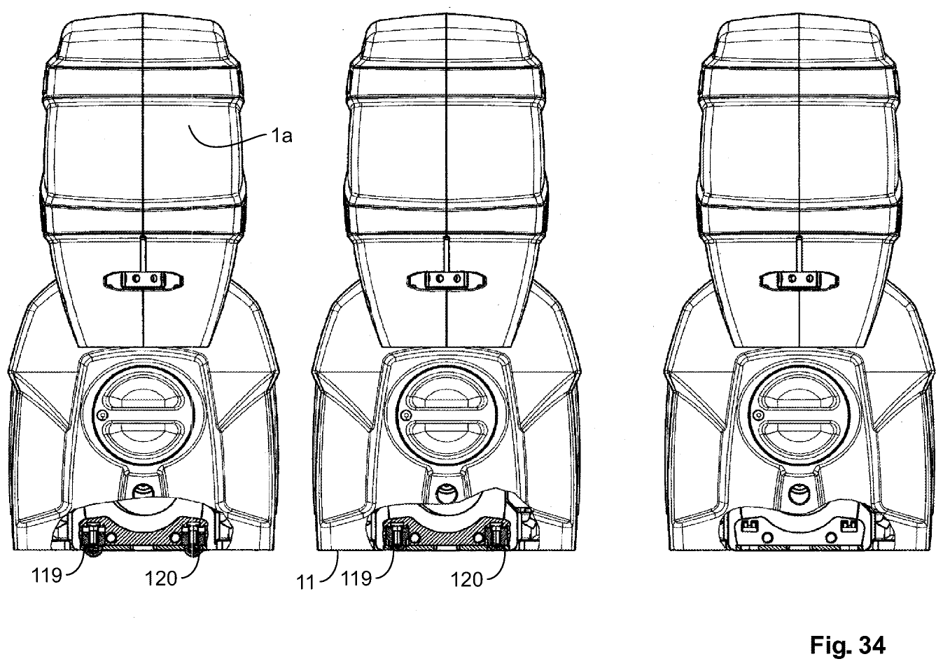

The figures show exemplary embodiments of other aspects according to the present disclosure. Thus, for example, FIG. 20-28 show the stapler 1 with its housing, where the stapler 1 comprises a device 70 of emitting light from the housing. The light-emitting device 70 is situated at the front end la of the housing. In the exemplary embodiment, this light-emitting device 70 is a line laser, which is situated in the housing above the ejecting channel 9. The laser 70 emits in the forward direction from a housing opening 71 in front of the stapler 1. As can be seen in FIGS. 20, 21, the line laser emits, as its light beam 72, a light plane directed at the particular object. This light plane can be perceived on the object as a projected straight running line 72a. Since the laser 70 emits light from the housing opening 71 in the as exactly as possible middle parting plane of the housing, which is also situated in the middle of the ejecting channel 9 and in the middle of the base leg 12a of the staples, especially the staples 12 which are present in the ejecting channel 9, the projected line 72a reflects the middle of the base leg 12a of the staples 12 being ejected. Hence, an operator of the stapler can set the staples 12 as precisely as possible, orienting himself to the line 72a projected onto the particular object, which indicates—in terms of the longitudinal extension of the base leg 12a—the middle of the base leg 12a, if a staple ejection were to take place in this position of the stapler. Thus, the line laser 70 has the function of a positioning aid and the operator can orient himself to the projected line 72a to achieve a particular orientation of the stapler 1 and thus a particular orientation of a staple 12 to be ejected.

In some embodiment, the light-emitting device 70, designed here as a line laser, as well as any other conceivable light-emitting device as a positioning aid, are able to be switched on and off, for example, by a switch or a button on the stapler 1. Likewise, in certain embodiments of a stapler according to the present disclosure, it may be provided that an automatic switching on and off of the respective light-emitting device is provided when certain conditions are present, in particular, it can be switched on and off as a function. For example, an automatic switching on may occur when an operator touches the trigger 29 or his finger comes close to it and is detected. In addition or alternatively, it may also be provided that the at least one detecting device 19, 20 in the area of the contact surface 11 must detect the presence of an object directly beneath the contact surface 11 in order for the respective light-emitting device to be automatically switched on for the display of optically perceivable position information in regard to a staple position.

The line laser 70 has a round circular housing 74 in cross section, which is arranged inside the housing of the stapler 1 in a holder 75. The holder 75 likewise has a round circular receptacle 76 in cross section for this purpose, in which the line laser 70 is arranged and mounted. A longitudinal axis of the round circular receptacle 76 is directed downward at a slant onto the respective object and with a spacing in front of the stapler 1. On the outer surface 74a of the housing 74 of the line laser 70 there is arranged an elastically stretched O-ring 77. A segment of the O-ring 77 is situated in a recess 78 of the wall of the holder 75, so that this segment of the O-ring 77 is accessible to grasping. By a rotary activation of the O-ring 77 through the recess 78, it is possible to change the rotary position of the line laser 70 in its holder 75. The O-ring 77, arranged rigidly on the housing 74 of the laser 70, carries along the laser 70 during this activation, so that the laser 70 rotates in the holder 75. The slight clamping of the O-ring 77 in the holder 75, which is also present, is overcome during the activation and allows very slight angles of rotation of the laser 70 in the holder 75 to be performed and adjusted.

By rotating the laser 70, the orientation of the line 72a projected by it on an object can be changed. A deviation of the actual rotary position from the designed nominal position possibly occurring when installing the laser 70 in the holder 75 might mean that the projected (light) line 72a has at least a slight slanted trend in regard to the base leg 12a of the respective staple 12. With the O-ring 77 and the recess 78 in the holder 75, a correction of such wrong orientations can be done quickly and easily and the laser can be oriented exactly in its nominal position. Such a correction can even be done quickly and easily after the assembly and delivery of the stapler, if such a wrong orientation is discovered only during use.

The drawings show two further light-emitting devices 80, which likewise indicate position information on a staple 12 being ejected. These two light-emitting devices may likewise be lasers, especially as line lasers. The two identically designed light-emitting devices 80 are each situated on one side of the stapler beneath the housing and substantially above the ejecting channel. The respective line laser 80 likewise emits its light from a housing opening slanting downward onto the particular object and it can once again be optically perceived there as a straight projected line. The layout and arrangement of the two line lasers 80 as well as their arrangement in a holder including a possibility of adjustment can be provided in accordance with the solution for the laser 70.

Each of the two lasers 80 emit a light plane on different sides of the stapler, each of them projecting a line 80a on the particular object, being oriented perpendicular to the line 70a and aligned with the center line of the ejecting channel. The lines 80a furthermore run in alignment with the base leg 12a of a staple 12 being ejected. Moreover, the lines 80a projected by the lasers 80 on either side of the stapler are aligned with each other. Thus, the two light-emitting devices signal the longitudinal trend of a base leg 12a of a staple being ejected or the plane in which the three legs of a staple 12 being ejected are situated. Hence, the two light-emitting devices 80 interacting with each other also serve as a positioning aid to eject a staple in a predeterminable position and set it in an object.

In an alternative embodiment, the light-emitting devices 70, 80 may also be formed with light sources other than lasers. Thus, in other embodiments, lasers may be replaced in particular by one or more LEDs 86. In particular for LEDs as the light-emitting device 80, a kind of light shaft 85 can be formed each time on the housing, which in certain embodiments has a transparent or at least partly transparent cover 84. The respective light shaft 85 in certain embodiments lies in the plane whose position is to be indicated by the respective light-emitting devices. Thus, if the stapler has a light shaft on either side of the stapler 1 with at least one shining LED situated therein, and capable of being switched on and off, then each of the two light shafts 85 will be situated within the staple plane formed by the three legs of the staple being ejected.

In one embodiment of the stapler 1 according to the present disclosure, one or more light-emitting devices may also be provided in a light shaft, especially devices which can shine in different colors. Alternatively, two or more light-emitting devices can also be provided in a light shaft each of them shining in only one, but not the same color. Different colors can, however, also be produced by lasers as the light-emitting devices. With such embodiments, it is possible to signal not only position information but also one or more further pieces of operating or state information, such as whether the stapler 1 is ready for use, and/or whether a malfunction is present and/or which mode the stapler is in and/or whether the detection device of the trigger 29 has detected a finger on the trigger 29. Instead of or in addition to different colors for relaying optically perceivable information, blinking signals of the light-emitting devices or otherwise varying light emissions of the particular light-emitting devices can also be provided.

The figures also show the display/control device of the stapler as a membrane keypad 33. The membrane keypad in the one exemplary embodiment is arranged on a sloping side surface of the main housing section 2 of the stapler 1. This membrane keypad 33 may have buttons for various functions which can be set or called up. In particular, the membrane keypad may be provided with one or more buttons for setting the operating modes. Likewise, the membrane keypad 33 may be provided with optically perceivable display devices, to signal set functions, values, malfunctions, charge state of the storage battery and/or operating modes in an optically perceivable manner. Such display devices may be light-emitting devices and/or alphanumerical displays integrated in the membrane keypad. Optionally, light-emitting devices and/or alphanumerical displays can also be integrated in buttons of the membrane keypad. The light-emitting devices and/or the at least one alphanumerical display may also optionally represent optically perceivable information in different and changing colors, just as a blinking mode is also possible for this. In this way, in particular, warning colors such as red can indicate especially important information. In other embodiments according to the present disclosure, the stapler may also be provided with alternative display and control devices. One such device can be a touchscreen, for example.

Various embodiments of the stapler of the present disclosure comprise a housing assembly with a main housing section and a handle section that extends away from the main housing section, wherein an ejector device is arranged in the main housing section, by way of which each time a fastener can be accelerated to eject the fastener from an exit opening of the stapler, a magazine device for holding a supply of fastener on the stapler, a driving device for the ejector device, which comprises an electric motor as well as a power supply device, which is designed in particular as an energy storage device, such as a rechargeable electrical storage battery, which can be or is electrically connected to the electric motor, at least one triggering device with an activatable trigger, by whose activation at least one fastener can be accelerated by way of the ejector device thereby set in motion and ejected from the exit opening, wherein the activatable trigger is arranged in the area of the handle section of the housing. The electric motor is arranged in the handle gripping section and its axis of rotation does not run parallel to a longitudinal axis of a path of acceleration of the ejector.

In certain such embodiments, the power supply device is situated in the area of one end of the handle, such as at the end of the handle.

In certain such embodiments, the power supply device is an interchangeable electric storage battery, which can be installed in a receptacle arranged at one end of the handle section and from which it can be removed, while at least one electric power supply line for the motor is arranged solely in the handle.

In certain such embodiments, the handle section of the housing is provided with a grip, especially an ergonomically configured grip.

In certain such embodiments, the axis of rotation in relation to an acceleration path of the ejector is an angle chosen from a range of 60° to 120°, preferably with an angle of at least approximately 90°.

In certain such embodiments, the electric motor situated in the handle section is a brushless direct-current motor.

In certain such embodiments, a gearing switched in after the motor and situated in the handle, especially a planetary gearing.

Other embodiments of the stapler of the present disclosure comprise a housing assembly with a main housing section and a handle section, which extends away from the main housing section, wherein an ejector device is arranged in the main housing section, by way of which each time a fastener can be accelerated to eject the fastener from an exit opening of the stapler, a magazine device for holding a supply of staples on the stapler, which can be releasably attached in the area of an ejecting channel on a carrier piece of the stapler by way of a quick lock, a driving device for the ejector device, which can be or is connected to a power supply device, at least one triggering device of a triggering device with an activatable trigger, by whose activation at least one fastener can be accelerated by way of the ejector device thereby set in motion and ejected from the exit opening; characterized by a fill level display or a fill level signal device for signaling a supply of staples contained in the magazine.

In certain such embodiments, the fill level display or the fill level signal device is arranged on the magazine.

In certain such embodiments, different optically perceptible markings are provided to symbolize the respective fill level.

In certain such embodiments, markings, especially different colored markings, of the fill level display are arranged on one wall of the magazine.

In certain such embodiments, a spring-loaded slide in the magazine, which is provided for the advancing of a stack of staples in the magazine, wherein the slide is provided with an indication device, especially a line or arrow oriented to the markings, with which the fill level display each time indicates a currently present supply of staples in the magazine.

In certain such embodiments, the stapler comprises a device for outputting an acoustic signal representing a determined fill level.

Other embodiments of the stapler of the present disclosure comprise a housing assembly with a main housing section and a handle section, which extends away from the main housing section, wherein an ejector device is arranged in the main housing section, by way of which each time a fastener can be accelerated to eject the fastener from an exit opening of the stapler, a magazine device for holding a supply of staples on the stapler, a driving device for the ejector device, which can be or is connected to a power supply device, at least one triggering device of a triggering device with an activatable trigger, by whose activation at least one fastener can be accelerated by way of the ejector device thereby set in motion and ejected from the exit opening, characterized by at least one light-emitting device arranged in the housing assembly, which is situated such that its emitted light contains optically perceptible position information on U-shaped staples which can be ejected by the stapler.

In certain such embodiments, the stapler includes at least one light-emitting device with which a directed light beam can be emitted from the housing in the direction of an object.

In certain such embodiments, the light beam contains optically perceptible position information about a plane in which a staple plane of ejectable staples extends.

In certain such embodiments, the light beam contains optically perceptible position information about a midplane of ejectable staples.

In certain such embodiments, the at least one light-emitting device is situated in the housing assembly and contains position information about a plane in which a staple plane of ejectable staples extends, especially U-shaped staples.

In certain such embodiments, the at least one light-emitting device is situated in the housing assembly behind a transparent or at least semitransparent cover or a luminous body or an optical fiber.

In certain such embodiments, the stapler includes at least two light-emitting devices arranged on the housing, which contain on two different sides of the housing assembly position information about a plane in which a staple plane of ejectable staples extends.

In certain such embodiments, the stapler includes multiple different light-emitting device, with which light can be emitted in different colors, or by the at least one light-emitting device with which light can be emitted in different colors, wherein the different colors in addition to the position information can also represent state information about the stapler in an optically perceptible manner.

In certain such embodiments, the stapler includes an adjusting device of the light-emitting device, by which a position of the light-emitting device in a holder can be changed so that a direction of emission of the light emitted by the light-emitting device can be changed and set.

In certain such embodiments, the adjusting device can change and set a rotation position of the light-emitting device in its holder.

Other embodiments of the stapler of the present disclosure include a housing assembly with a main housing section and a handle section, which extends away from the main housing section (3), wherein an ejector device is arranged in the main housing section, by way of which each time a fastener can be accelerated to eject the fastener from an exit opening of the stapler, a magazine device for holding a supply of staples on the stapler, a driving device for the ejector device, which can be or is connected to a power supply device, at least one triggering device of a triggering device with an activatable trigger, by whose activation at least one fastener can be accelerated by way of the ejector device thereby set in motion and ejected from the exit opening, characterized in that the at least one triggering device comprises a detection device for the detection of a body part, especially a finger, placed on the trigger.

In certain such embodiments, the detection device for the detection of a body part placed on the trigger is situated in the activatable trigger or on the housing immediately alongside the activatable trigger.

In certain such embodiments, the detection device for the detection of a body part placed on the trigger contains a proximity sensor, a photodiode or a photoresistor.

In certain such embodiments, the stapler includes a device with which a detection signal of the detection device can be sent to a control system of the stapler, and the control system is designed such that the detection signal is a requirement for the releasing of an ejecting of a staple.

In certain such embodiments, the detection signal for the presence of a body part can be utilized to switch on the at least one light-emitting device.

In certain such embodiments, the stapler includes at least one detecting device in the area of the contact surface to detect the presence of an object beneath the contact surface.

In certain such embodiments, the stapler includes a device with which a detection signal of the detecting device can be sent to a control system of the stapler, and the control system is designed such that the detection signal of the at least one detecting device is a requirement for the releasing of the ejecting of a staple.

In certain such embodiments, the electric motor is situated in the handle gripping section and its axis of rotation runs not parallel to a longitudinal axis of an acceleration path of the ejector.

In certain such embodiments, the activatable trigger is situated in the area of the handle section of the housing.

In certain such embodiments, the trigger can be activated against the spring forces of at least two spring elements, wherein upon an activation, the trigger is at first activated only against the spring force of the first spring and only during the further activation is the trigger activated against the spring forces of both spring elements.

In certain such embodiments, the stapler includes a clinch device with which two legs of a staple emerging from an exit opening of the stapler can be bent.

Other embodiments of the stapler of the present disclosure include a housing assembly with a main housing section and a handle section, which extends away from the main housing section, wherein an ejector device is arranged in the main housing section, by way of which each time a fastener can be accelerated to eject the fastener from an exit opening of the stapler, a magazine device for holding a supply of staples on the stapler, a driving device for the ejector device, which can be or is connected to a power supply device, a clinch device by which two legs of a staple emerging from an exit opening of the stapler can be bent, at least one triggering device of a triggering device with an activatable trigger, by whose activation at least one fastener can be accelerated by way of the ejector device thereby set in motion and ejected from the exit opening, characterized in that at least one detecting device for detecting the presence of an object beneath the contact surface is provided in the area of the contact surface at which at least one clinch element of the clinch device for the bending of staples emerges from the contact surface during a stapling process.

In certain such embodiments, the stapler includes at least two detecting device are provided in the area of the contact surface, arranged spaced apart from each other.

In certain such embodiments, the at least two detecting device arranged at a spacing from each other are situated in the area of mutually opposite side edges of the substantially rectangular exit opening.

In certain such embodiments, the at least two detecting device are situated in the area of the two mutually opposite side edges of the exit opening and arranged with a larger spacing from each other.

In certain such embodiments, the at least one detecting device is an optical detecting device.

In certain such embodiments, the at least one detecting device is a mechanically activatable detecting device.

In certain such embodiments, the stapler includes a device of the triggering device with which at least two different operating modes of the stapler can be set, whereby in the first operating mode only one stapling process can be triggered by a single activating of the triggering device, such that only one staple can be ejected and its legs can be bent by way of the clinch device, and in a second operating mode multiple successive stapling processes can be triggered with a single activating of the triggering device, such that each time one staple can be ejected and its legs can be bent by way of the clinch device.

In certain such embodiments, the second operating mode each stapling process with a staple occurring after a single triggering process can only be enabled by the control system of the stapler after the at least one detecting device has detected an object underneath the contact surface.

In certain such embodiments, in the second operating mode each stapling process occurring after a single triggering process can only be enabled by the control system of the stapler after both of the at least two detecting devices situated at a spacing from each other have detected an object underneath the contact surface.

In certain such embodiments, the at least one triggering device comprises a detection device for the detection of a body part located on the trigger, especially a finger.

In certain such embodiments, the stapler includes a device with which a detection signal of the detection device can be sent to a control system of the stapler, and the control system is designed such that the detection signal is a requirement for the releasing of the ejecting of a staple.

Other embodiments of the stapler of the present disclosure include a housing assembly with a main housing section and a handle section, which extends away from the main housing section, wherein an ejector device is arranged in the main housing section, by way of which each time a fastener can be accelerated to eject the fastener from an exit opening of the stapler, a magazine device for holding a supply of staples on the stapler, a driving device for the ejector device, which can be or is connected to a power supply device, a clinch device by which two legs of a staple emerging from an exit opening of the stapler can be bent, at least one triggering device of a triggering device with an activatable trigger, by whose activation at least one fastener can be accelerated by way of the ejector device thereby set in motion and ejected from the exit opening, characterized in that device of the triggering device are provided with which at least two different operating modes of the stapler can be set, whereby in the first operating mode only a stapling process can be triggered by an activation of the triggering device such that only one staple can be ejected and its legs can be bent by way of the clinch device, and in a second operating mode several consecutive stapling processes can be triggered with one, and in certain embodiments only one, activation of the triggering device, such that each time one staple can be ejected and its legs can be bent by way of the clinch device.

In certain such embodiments, the stapler includes at least one releasing device provided in addition to the triggering device, which provides a release signal to perform a stapling process to the control system in at least one of the two operating modes when a predetermined condition is fulfilled.

In certain such embodiments, the releasing device comprises at least one detecting device with which a presence of an object in the area of the contact surface can be detected, especially a contact between the contact surface and the object.

In certain such embodiments, the stapler includes at least one detecting device for detecting the presence of an object beneath the contact surface is provided in the area of the contact surface.

In certain such embodiments, the stapler includes a detecting device as the releasing device arranged in the area of the trigger, with which a presence of a body part on the trigger can be detected.

In certain such embodiments, the stapler is operable in a semiautomatic operating mode, in which when the trigger is permanently activated one stapling process of a series of stapling processes can in each case be performed after the stapler is lifted off from the object after a previous stapling process and then set back down on the object, wherein the lifting off and setting down once more can be detected by way of at least one detection device.

In certain such embodiments, the stapler is operable in an automatic mode, in which when the trigger is permanently activated in a given interval of time, stapling processes of a series of stapling processes can in each case be performed, wherein stapling processes can be performed for as long as the trigger remains activated and the stapler is present by its contact surface on an object without interruption.

In certain such embodiments, the time interval can be adjusted and/or set in a teach-in mode of the stapler.

In certain such embodiments, the driving device comprises an electric motor and a storage battery which can be connected to the motor.

Other embodiments of the stapler of the present disclosure include a housing assembly with a main housing section and a handle section, which extends away from the main housing section, wherein an ejector device is arranged in the main housing section, by way of which each time a fastener can be accelerated to eject the fastener from an exit opening of the stapler, a magazine device for holding a supply of staples on the stapler, which can be releasably attached in the area of an ejecting channel on a carrier piece of the stapler by way of a quick lock, a driving device for the ejector device, which can be or is connected to a power supply device, at least one triggering device of a triggering device with an activatable trigger, by whose activation at least one fastener can be accelerated by way of the ejector device thereby set in motion and ejected from the exit opening; characterized by a display and control device having a membrane keypad device, which comprises control elements as membrane keypad elements by whose activation one can adjust settings for the stapler and/or change the states of the stapler.

In certain such embodiments, the stapler can be switched to a single ejection operating mode and a semiautomatic operating mode in which several stapling processes can be performed in succession after only a single activating of the trigger, wherein the display and control device comprises display device for signaling the operating mode which is switched on.

In certain such embodiments, the stapler includes a device for switching the stapler into an automatic mode in which stapling processes are performed automatically in succession at a given or predeterminable interval of time, wherein the display and control device comprises display device for signaling the operating mode which is switched on.

In certain such embodiments, the display and control device comprises at least one membrane keypad element for setting the operating mode.

In certain such embodiments, the stapler includes a display device for signaling a malfunction of the stapler.

In certain such embodiments, the stapler includes a display device for a charge state of a storage battery.

In certain such embodiments, the display device for the charge state can also signal a malfunction of the stapler, especially by a different display mode of the display device, especially by a change in color and/or by a change into blinking mode.

In certain such embodiments, the stapler includes at least one light-emitting device arranged in the housing assembly, which is situated such that its emitted light contains optically perceptible position information on the U-shaped staples which can be ejected from the stapler.

In certain such embodiments, the display and control device comprises a display device to signal an on state of the light-emitting device.

In certain such embodiments, the membrane keypad device comprises a membrane keypad operating piezoelectrically or by way of mechanical click switches.

In certain such embodiments, the display and control device is arranged on a side surface, especially an inclined side surface, of the main housing section.

Other embodiments of the stapler of the present disclosure include a housing assembly with a main housing section and a handle section, which extends away from the main housing section, wherein an ejector device is arranged in the main housing section, by way of which each time a fastener can be accelerated to eject the fastener from an exit opening of the stapler, a magazine device for holding a supply of staples on the stapler, which can be releasably attached in the area of an ejecting channel on a carrier piece of the stapler by way of a quick lock, a driving device for the ejector device, which can be or is connected to a power supply device, at least one triggering device of a triggering device with an activatable trigger, by whose activation at least one fastener can be accelerated by way of the ejector device thereby set in motion and ejected from the exit opening, characterized in that the quick lock is provided with guiding device, which move the magazine in succession in two different directions, not parallel to each other, during the movement of installing the magazine on the carrier piece.

In certain such embodiments, the stapler includes guiding device, which guides the movement of the magazine in succession in two mutually perpendicular directions during a movement of installing the magazine.

In certain such embodiments, one of the two directions is oriented at least substantially parallel to a flat contact surface of the stapler on which the exit opening is situated.

In certain such embodiments, to remove a magazine arranged on the stapler the guiding device are configured such that the stapler can move parallel to the contact surface as far as an end stop and then the stapler can be lifted off from the magazine.

In certain such embodiments, the stapler includes a hand-operable releasing device of the quick lock, with which a locking or a form fitting of the quick lock can be removed.

In certain such embodiments, the quick lock, especially a swivel lever of the quick lock, is provided with a locking lug which interacts with the magazine.

In certain such embodiments, the stapler includes a profiled locking lug, which in a locking position lies against two nonparallel surfaces of the magazine, such that both a movement trajectory of the locking lug is limited and a form fitting locking of the quick lock occurs.

In certain such embodiments, at least one swivel lever of the quick lock, which can swivel about a swivel axis running perpendicular to the contact surface.

In certain such embodiments, the swivel lever can be pretensioned with a spring element, wherein the swivel lever can be swiveled against a spring force of the spring element about the swivel axis and a locking lug of the swivel lever can be lifted out from a locking position to remove the magazine.

In certain such embodiments, the swivel axis extends through the swivel lever.

In certain such embodiments, a self-locking of the quick lock when a tensile force is exerted on the magazine and when a swivel lever is not activated.

In certain such embodiments, the electric motor is situated in the handle section of the housing and an axis of rotation of the electric motor extends not parallel to a longitudinal axis of an acceleration path of the ejector.

In certain such embodiments, the stapler includes a clinch device, by which two legs of a staple emerging from an exit opening of the stapler can be bent.

Other embodiments of the stapler of the present disclosure include a housing assembly with a main housing section and a handle section, which extends away from the main housing section, wherein an ejector device is arranged in the main housing section, by way of which each time a fastener can be accelerated to eject the fastener from an exit opening of the stapler, a magazine device for holding a supply of staples on the stapler, which can be releasably attached in the area of an ejecting channel on a carrier piece of the stapler by way of a quick lock, a driving device for the ejector device, which can be or is connected to a power supply device, at least one triggering device of a triggering device with an activatable trigger, by whose activation at least one fastener can be accelerated by way of the ejector device thereby set in motion and ejected from the exit opening, characterized by a quick lock, which is provided with a hand-operable releasing device of the quick lock, wherein a locking or form fitting of the quick lock can be removed by way of the releasing device, and wherein the quick lock comprises as releasing device at least one swivel lever, which can swivel about a swivel axis running at least substantially perpendicular to the contact surface.

Other embodiments of the stapler of the present disclosure include a housing assembly with a main housing section and a handle section, which extends away from the main housing section, wherein an ejector device is arranged in the main housing section, which has an ejector, by way of which each time a fastener can be accelerated to eject the fastener from an exit opening of the stapler, a magazine device for holding a supply of staples on the stapler, which can be releasably attached in the area of an ejecting channel on a carrier piece of the stapler by way of a quick lock, a driving device for the ejector device, which can be or is connected to a power supply device, at least one triggering device of a triggering device with an activatable trigger, by whose activation at least one fastener can be accelerated by way of the ejector device thereby set in motion and ejected from the exit opening, characterized by a blocking device, which can be arranged in at least two end positions, wherein the blocking device in its first end position is located in the movement trajectory of the ejector and in the second end position it clears the movement trajectory of the ejector.

In certain such embodiments, the blocking device can be converted from its first to its second end position by way of a magazine of the magazine device which can be introduced into its receptacle on the stapler.

In certain such embodiments, the blocking device is swivel-mounted on the stapler, and in that the magazine located in its receptacle on the stapler holds the blocking device in its second end position, wherein the blocking device is releasable by the magazine when the magazine is removed from the stapler, so that the blocking device can swivel from its second end position to its first end position and in this way blocks the ejector.

What is claimed is:

1. A stapling device comprising:
a housing comprising a contact surface and defining an ejection channel terminating in an ejection opening defined in the contact surface;
an ejector movable in the ejection channel between an upper position and a lower position;
a magazine removably attached to the housing and configured to, when attached to the housing and when storing one or more staples, position a first staple of the one or more staples in the ejection channel, wherein the magazine is removable from the housing via movement in a first direction followed by movement in a second direction transverse to the first direction; and
a drive operably connected to the ejector and configured to move the ejector from the upper position to the lower position to, when the magazine is attached to the housing and storing the one or more staples, engage the first staple in the ejection channel and eject the first staple out of the ejection opening.

2. The stapling device of claim 1, wherein the second direction is perpendicular to the first direction.

3. The stapling device of claim 1, wherein the contact surface is planar, wherein the first direction is parallel to the contact surface.

4. The stapling device of claim 3, wherein the second direction is perpendicular to the first direction.

5. The stapling device of claim 1, further comprising a lever movable between a first position and a second position, wherein when the magazine is attached to the housing and the lever is in the first position, the lever prevents the magazine from moving in the first direction, wherein when the magazine is attached to the housing and the lever is in the second position, the lever does not prevent the magazine from moving in the first direction.

6. The stapling device of claim 5, wherein the lever is biased to the first position.

7. The stapling device of claim 5, wherein the lever is pivotable between the first position and the second position.

8. The stapling device of claim 7, wherein the lever is pivotable about a pivot axis that is parallel to the ejection channel.

9. The stapling device of claim 1, wherein the housing comprises a guide body defining a slot and an opening in communication with the slot, wherein the magazine comprises a projection, wherein when the magazine is attached to the housing, the projection is at least partially received in the slot to prevent the magazine from moving in the second direction.

10. The stapling device of claim 9, wherein the projection is removed from the slot and positioned in the opening after the magazine has moved in the first direction to enable the magazine to move in the second direction.

11. The stapling device of claim 1, further comprising a blocking device movable between a first position and a second position, wherein when the blocking device is in the first position, the blocking device prevents movement of the ejector from the upper position to the lower position, wherein when the blocking device is in the second position, the blocking device does not prevent the ejector from moving from the upper position to the lower position.

12. The stapling device of claim 11, wherein the blocking device is in the first position when the magazine is not attached to the housing and in the second position when the magazine is attached to the housing.

13. The stapling device of claim 12, wherein the blocking device is pivotable between the first and second positions and is biased to the first position.

14. The stapling device of claim 13, wherein the blocking device comprises a first leg and a second leg, wherein the first leg is in the ejection channel when the blocking device is in the first position and is removed from the ejection channel when the blocking device is in the second position.

15. The stapling device of claim 14, wherein the magazine contacts the second leg of the blocking device when the magazine is attached to the housing to maintain the blocking device in the second position.

16. The stapling device of claim 1, wherein the housing comprises a handle having a free end, wherein the drive is positioned in the handle, the stapling device further comprising a battery removably attached to the free end of the handle.

17. The stapling device of claim 1, further comprising:
an activatable trigger; and
a control system configured to, when in a semi-automatic operating mode:
responsive to a first triggering condition being met, control the drive to cause the ejector to move from the upper position to the lower position; and
after the first triggering condition has been met, responsive to a second triggering condition being met, control the drive to cause the ejector to move from the upper position to the lower position,
wherein the first triggering condition and the second triggering condition are different.

18. The stapling device of claim 1, wherein the magazine comprises a fill-level indicator indicating a quantity of staples in the magazine.

19. The stapling device of claim 1, further comprising a light-emitting device configured to project a light beam that identifies a staple orientation.

20. The stapling device of claim 19, further comprising a control system configured to activate the light-emitting device responsive to a triggering condition being met.
